(19) United States
(12) Patent Application Publication
(10) Pub. No.: US 2006/0046214 A1
(43) Pub. Date: Mar. 2, 2006

(54) Photothermographic materials with reduced development time

(75) Inventor: Bryan V. Hunt, Fridley, MN (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/925,728

(22) Filed: Aug. 25, 2004

(51) Int. Cl. G03C 1/00

(52) U.S. Cl. 430/619

(57) ABSTRACT

Black-and-white photothermographic materials can be developed in shorter times (less than 15 seconds) with a combination of imaging components that include a reducing agent at up to 0.32 mol/mol of total silver and specific amounts of certain toning agents.

### FIELD OF THE INVENTION

This invention relates to photothermographic materials that after imaging require a short development time. In particular, this invention relates to photothermographic materials having a specific combination of chemical components that allow for shorter development times. This invention also relates to methods of imaging using these thermally developable materials.

### BACKGROUND OF THE INVENTION

Silver-containing photothermographic imaging materials (that is, photosensitive thermally developable imaging materials) that are imaged with actinic radiation and then developed using heat and without liquid processing have been known in the art for many years. Such materials are used in a recording process wherein an image is formed by imagewise exposure of the photothermographic material to specific electromagnetic radiation (for example, X-radiation, or ultraviolet, visible, or infrared radiation) and developed by the use of thermal energy. These materials, also known as “dry silver” materials, generally comprise a support having coated thereon: (a) a photocatalyst (that is, a photosensitive compound such as silver halide) that upon such exposure provides a latent image in exposed grains that are capable of acting as a catalyst for the subsequent formation of a silver image in a development step, (b) a relatively or completely non-photosensitive source of reducible silver ions, (c) a reducing composition (usually including a developer) for the reducible silver ions, and (d) a hydrophilic or hydrophobic binder. The latent image is then developed by application of thermal energy.

In photothermographic materials, exposure of the photographic silver halide to light produces small clusters containing silver atoms (Ag⁰)ₙ. The imagewise distribution of these clusters, known in the art as a latent image, is generally not visible by ordinary means. Thus, the photosensitive material must be further developed to produce a visible image. This is accomplished by the reduction of silver ions that are in catalytic proximity to silver halide grains bearing the silver-containing clusters of the latent image. This produces a black-and-white image. The non-photosensitive silver source is catalytically reduced to form the visible black-and-white negative image while much of the silver halide, generally, remains as silver halide and is not reduced.

In photothermographic materials, the reducing agent for the reducible silver ions, often referred to as a “developer,” may be any compound that, in the presence of the latent image, can reduce silver ion to metallic silver and is preferably of relatively low activity until it is heated to a temperature sufficient to cause the reaction. A wide variety of classes of compounds have been disclosed in the literature that function as developers for photothermographic materials. At elevated temperatures, the reducible silver ions are reduced by the reducing agent. This reaction occurs preferentially in the regions surrounding the latent image. This reaction produces a negative image of metallic silver having a color that ranges from yellow to deep black depending upon the presence of toning agents and other components in the photothermographic imaging layer(s).

Differences Between Photothermography and Photography

The imaging arts have long recognized that the field of photothermography is clearly distinct from that of photography. Photothermographic materials differ significantly from conventional silver halide photographic materials that require processing with aqueous processing solutions.

In photothermographic imaging materials, a visible image is created by heat as a result of the reaction of a developer incorporated within the material. Heating at 50° C. or more is essential for this dry development. In contrast, conventional photographic imaging materials require processing in aqueous processing baths at more moderate temperatures (from 30° C. to 50° C.) to provide a visible image.

In photothermographic materials, only a small amount of silver halide is used to capture light and a non-photosensitive source of reducible silver ions (for example, a silver carboxylate or a silver benzotriazole) is used to generate the visible image using thermal development. Thus, the imaged photosensitive silver halide serves as a catalyst for the physical development process involving the non-photosensitive source of reducible silver ions and the incorporated reducing agent. In contrast, conventional wet-processed, black-and-white photographic materials use only one form of silver (that is, silver halide) that, upon chemical development, is itself at least partially converted into the silver image, or that upon physical development requires addition of an external silver source (or other reducible metal ions that form black images upon reduction to the corresponding metal). Thus, photothermographic materials require an amount of silver halide per unit area that is only a fraction of that used in conventional wet-processed photographic materials.

In photothermographic materials, all of the “chemistry” for imaging is incorporated within the material itself. For example, such materials include a developer (that is, a reducing agent for the reducible silver ions) while conventional photographic materials usually do not. The incorporation of the developer into photothermographic materials can lead to increased formation of various types of “fog” or other undesirable sensitometric side effects. Therefore, much effort has gone into the preparation and manufacture of photothermographic materials to minimize these problems.

Moreover, in photothermographic materials, the unexposed silver halide generally remains intact after development and the material must be stabilized against further imaging and development. In contrast, silver halide is removed from conventional photographic materials after solution development to prevent further imaging (that is, in the aqueous fixing step).

Because photothermographic materials require dry thermal processing, they present distinctly different problems and require different materials in manufacture and use, compared to conventional, wet-processed silver halide photographic materials. Additives that have one effect in conventional silver halide photographic materials may behave quite differently when incorporated in photothermographic materials where the underlying chemistry is significantly more complex. The incorporation of such additives as, for example, stabilizers, antifoggants, speed enhancers, supersensitizers, and spectral and chemical sensitizers in conventional photographic materials is not predictive of whether such additives will prove beneficial or detrimental in photothermographic materials. For example, it is not uncommon for a photographic antifoggant useful in conventional photographic materials to cause various types of fog when incorporated into photothermographic materials, or for supersensitizers that are effective in photographic materials to be inactive in photothermographic materials.

These and other distinctions between photothermographic and photographic materials are described in Unconventional Imaging Processes, E. Brinckman et al. (Eds.), The Focal Press, London and New York, 1978, pp. 74-75, in D. H. Klosterboer, Imaging Processes and Materials. (Neblette's Eighth Edition), J. Sturge, V. Walworth, and A. Shepp, Eds., Van Nostrand-Reinhold, New York, 1989, Chapter 9, pp. 279-291, in Zou et al., J. Imaging Sci. Technol. 1996, 40, pp. 94-103, and in M. R. V. Sahyun, J. Imaging Sci. Technol. 1998, 42, 23.

Problem to be Solved

As noted above, after photothermographic materials are imaged using suitable radiation to provide a latent image, a visible image is produced by application of heat to the material. Development times used in most commercial processes usually require from 13 to 24 seconds and development temperatures are usually at least 110° C.

With improved non-invasive diagnostic imaging techniques, the demand for use of photothermographic materials is dramatically increasing. However, at the same time, healthcare providers are under intense pressure to improve productivity, that is, increase the number of images provided by each imaging machine. For this reason, imaging output systems or machines are being developed to provide higher throughput.

One approach to solving this productivity problem is to consider shorter development times. However, there is a need to find a way to reduce development time without any loss in sensitometric properties. For example, when photothermographic materials are developed at very short times, for example, less than 13 seconds, the resulting images often have poor Dₘₐₓ, tone, and/or stability.

U.S. patent application Publication 2004/0038156 (Oyamada et al.) describes imaging of photothermographic materials at a transportation speed of 23 mm/sec or faster and in some instances using a development time of 12 seconds or less. However, in the few examples where a development time less than 14 seconds is used, no teaching is given for these materials regarding the storage stability of nonimaged film, Dₘₐₓ, tone, and print stability upon storage at temperatures above 60° C. Additionally, there is no discussion of materials that can be use with development times of 8 seconds or less.

There is a continuing need for a way to provide increased imaging throughput or faster development time of imaged photothermographic materials without significant loss in desired sensitometric properties.

### SUMMARY OF THE INVENTION

The present invention provides a black-and-white photothermographic material that comprises a support having on one side thereof, one or more thermally developable imaging layers comprising a binder and in reactive association, a photosensitive silver halide, a non-photosensitive source of reducible silver ions, and a reducing agent composition for the non-photosensitive source reducible silver ions,

the material further comprising at least one compound represented by the following Structure I and at least one compound represented by the following Structure II: 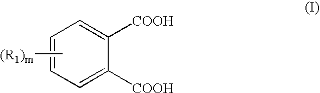
wherein R₁ represents an alkyl group, aryl group, alkoxy group, aryloxy group, halo group, cyano group, or nitro group, m is 0 or an integer up to 4, and when m is greater than or equal to 2, a plurality of R₁ groups may be the same or different, and when present, two or more R₁ groups may form a fused aliphatic, aromatic, or heterocyclic fused ring, with the proviso that when m is 4, all R₁ are not chloro,

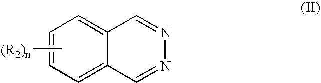

wherein R₂ represents hydrogen or a substituent, n is 0 or an integer up to 4, and when n is greater than or equal to 2, a plurality of R₂ groups may be the same or different and when present, two or more R₂ groups may form a fused aliphatic, aromatic, or heterocyclic ring,

wherein the amount of the reducing agent composition is at least 0.10 and up to and including 0.32 mol/mol of total silver, the amount of the compound represented by Structure I is at least 0.042 mol/mol of total silver, and the amount of the compound represented by Structure II is at least 0.10 mol/mol of total silver, and

wherein the material has, at the exposure wavelength, a total optical density of at least 0.1 of all layers on the imaging layer side of the support.

In preferred embodiments, this invention provides a black-and-white photothermographic material that comprises a transparent polymeric support having on one side thereof one or more thermally developable imaging layers comprising predominantly one or more hydrophobic binders comprising polyvinyl butyral, and in reactive association:

preformed photosensitive silver bromide or silver iodobromide present as tabular and/or cubic grains, which grains have an average size of from about 0.01 to about 0.06 μm, and are spectrally sensitized to infrared radiation,

a non-photosensitive source of reducible silver ions that includes silver behenate,

a reducing agent composition for the non-photosensitive source reducible silver ions comprising a compound represented by Structure III,

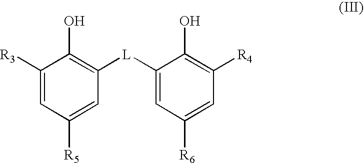

wherein R₃ and R₄ each independently represents a substituted or unsubstituted linear, branched, or cyclic alkyl group having 1 to 20 carbon atoms, R₅ and R₆ each independently represents hydrogen or a monovalent substituent such as an alkyl group, aryl group, halogen atom, or alkoxy group, and L represents —S— or —CHR₇ in which R₇ represents a hydrogen atom or a substituted or unsubstituted linear, branched, or cyclic alkyl group having 1 to 20 carbon atoms,

the material further comprising an organic polyhalo antifoggant in an amount of from about 0.029 to about 0.10 mol/mol of total silver, a benzotriazole compound in an amount of from about 0.005 to about 0.022 mol/mol of total silver, an isocyanate, and a propenenitrile,

the material further comprising at least one compound represented by the following Structure I and at least one compound represented by the following Structure II:

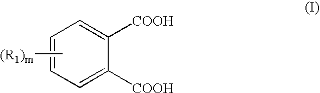

wherein, R₁ represents an alkyl group, aryl group, alkoxy group, aryloxy group, halo group, cyano group, or nitro group, m is 0 or an integer up to 4, and when m is greater than or equal to 2, a plurality of R₁ groups may be the same or different, and when present, two or more R₁ groups may form a fused aliphatic, aromatic, or heterocyclic fused ring, with the proviso that when m is 4, all R₁ are not chloro, and

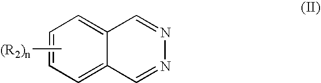

wherein R₂ represents hydrogen or a substituent, n is 0 or an integer up to 4, and when n is greater than or equal to 2, a plurality of R₂ groups may be the same or different and when present, two or more R₂ groups may form a fused aliphatic, aromatic, or heterocyclic ring,

wherein the amount of the reducing agent composition is from about 0.10 to about 0.32 mol/mol of total silver, the amount of the compound represented by Structure I is from about 0.042 to about 0.08 mol/mol of total silver, and the amount of the compound represented by Structure II is from about 0.10 to about 0.2 mol/mol of total silver, and

a protective layer disposed over the one or more thermally developable imaging layers, the material comprising total silver of from about 0.01 to about 0.02 mol/m²,

the material further having at the exposure wavelength a total optical density of at least 0.6 of all layers on the imaging layer side of the support and a total optical density of at least 0.2 of all layers on the backside of the support.

This invention also provides a method of forming a visible image comprising:

A) imagewise exposing a photothermographic material to electromagnetic radiation to form a latent image,

B) simultaneously or sequentially, heating the exposed photothermographic material for 1 to less than 15 seconds to develop the latent image into a visible image,

the photothermographic material comprising a support having on one side thereof, one or more thermally developable imaging layers comprising a binder and in reactive association, a photosensitive silver halide, a non-photosensitive source of reducible silver ions, and a reducing agent composition for the non-photosensitive source reducible silver ions,

the material further comprising at least one compound represented by the following Structure I and at least one compound represented by the following Structure II:

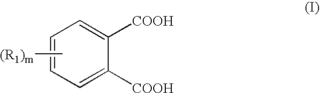

wherein R₁ represents an alkyl group, aryl group, alkoxy group, aryloxy group, halo group, cyano group, or nitro group, m is 0 or an integer up to 4, and when m is greater than or equal to 2, a plurality of R₁ groups may be the same or different, and when present, two or more R₁ groups may form a fused aliphatic, aromatic, or heterocyclic fused ring, with the proviso that when m is 4, all R₁ are not chloro, 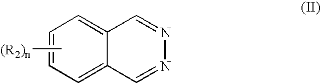
wherein R₂ represents hydrogen or a substituent, n is 0 or an integer up to 4, and when n is greater than or equal to 2, a plurality of R₂ groups may be the same or different and when present, two or more R₂ groups may form a fused aliphatic, aromatic, or heterocyclic ring, and

wherein the amount of the reducing agent composition is at least 0.10 and up to and including 0.32 mol/mol of total silver, the amount of the compound represented by Structure I is at least 0.042 mol/mol of total silver, and the amount of the compound represented by Structure II is at least 0.10 mol/mol of total silver.

A method of forming a visible image of this invention also comprises:

A) imagewise exposing a photothermographic material that has a transparent support to electromagnetic radiation to form a latent image,

B) simultaneously or sequentially, heating the exposed photothermographic material for sufficient time less than 15 seconds and temperature to develop the latent image into a visible image having a Dₘₐₓ of at least 3.0,

the photothermographic material comprising a support having on one side thereof, one or more thermally developable imaging layers comprising a binder and in reactive association, a photosensitive silver halide, a non-photosensitive source of reducible silver ions, and a reducing agent composition for the non-photosensitive source reducible silver ions,

the material further comprising at least one compound represented by the following Structure I and at least one compound represented by the following Structure II:

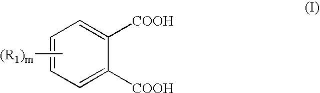

wherein I, R₁ represents an alkyl group, aryl group, alkoxy group, aryloxy group, halo group, cyano group, or nitro group, m is 0 or an integer up to 4, and when m is greater than or equal to 2, a plurality of R₁ groups may be the same or different, and when present, two or more R₁ groups may form a fused aliphatic, aromatic, or heterocyclic fused ring, with the proviso that when m is 4, all R₁ are not chloro,

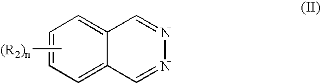

wherein R₂ represents hydrogen or a substituent, n is 0 or an integer up to 4, and when n is greater than or equal to 2, a plurality of R₂ groups may be the same or different and when present, two or more R₂ groups may form a fused aliphatic, aromatic, or heterocyclic ring, and

wherein the amount of the reducing agent composition is at least 0.10 and up to and including 0.32 mol/mol of total silver, the amount of the compound represented by Structure I is at least 0.042 mol/mol of total silver, and the amount of the compound represented by Structure II is at least 0.10 mol/mol of total silver.

These image-forming methods are particularly useful for providing images that can be used to provide a medical diagnosis of a human or animal subject.

The present invention provides a photothermographic material that can be developed for considerably less time, that is less than 15 seconds, and generally from about 5 to about 10 seconds without significant loss in desired sensitometric properties. The photothermographic material has these properties as a result of a combination of certain amounts of reducing agents and “toners” (or toning agents). Each of these components and the useful amounts are described below.

### DETAILED DESCRIPTION OF THE INVENTION

The photothermographic materials can be used in black-and-white or color thermography and photothermography and in electronically generated black-and-white or color hardcopy recording. They can be used in microfilm applications, in radiographic imaging (for example digital medical imaging), X-ray radiography, and in industrial radiography. Furthermore, the absorbance of these photothermographic materials between 350 and 450 nm is desirably low (less than 0.5), to permit their use in the graphic arts area (for example, image-setting and phototypesetting), in the manufacture of printing plates, in contact printing, in duplicating (“duping”), and in proofing.

The photothermographic materials are particularly useful for imaging of human or animal subjects in response to visible, X-radiation, or infrared radiation for use in a medical diagnosis. Such applications include, but are not limited to, thoracic imaging, mammography, dental imaging, orthopedic imaging, general medical radiography, therapeutic radiography, veterinary radiography, and autoradiography. When used with X-radiation, the photothermo-graphic materials may be used in combination with one or more phosphor intensifying screens, with phosphors incorporated within the photothermographic emulsion, or with combinations thereof. Such materials are particularly useful for dental radiography when they are directly imaged by X-radiation. The materials are also useful for non-medical uses of X-radiation such as X-ray lithography and industrial radiography.

The photothermographic materials can be made sensitive to radiation of any suitable wavelength. Thus, in some embodiments, the materials are sensitive at ultraviolet, visible, infrared, or near infrared wavelengths, of the electromagnetic spectrum. In preferred embodiments, the materials are sensitive to radiation greater than 700 nm (and generally up to 1150 nm). Increased sensitivity to a particular region of the spectrum is imparted through the use of various spectral sensitizing dyes.

In the photothermographic materials, the components needed for imaging can be in one or more photothermographic imaging layers on one side (“frontside”) of the support. The layer(s) that contain the photosensitive photocatalyst (such as a photosensitive silver halide) or non-photosensitive source of reducible silver ions, or both, are referred to herein as photothermographic emulsion layer(s). The photocatalyst and the non-photosensitive source of reducible silver ions are in catalytic proximity and preferably are in the same emulsion layer.

Where the photothermographic materials contain imaging layers on one side of the support only, various non-imaging layers are usually disposed on the “backside” (non-emulsion or non-imaging side) of the materials, including antistatic layers, conductive layers, antihalation layers, protective layers, and transport enabling layers.

Various non-imaging layers can also be disposed on the “frontside” or imaging or emulsion side of the support, including protective topcoat layers, primer layers, interlayers, opacifying layers, conductive layers, antistatic layers, antihalation layers, acutance layers, auxiliary layers, and other layers readily apparent to one skilled in the art.

For some embodiments, it may be useful that the photothermo-graphic materials be “double-sided” or “duplitized” and have the same or different thermally developable coatings (or imaging layers) on both sides of the support. In such constructions each side can also include one or more protective topcoat layers, primer layers, interlayers, acutance layers, auxiliary layers, anti-crossover layers, and other layers readily apparent to one skilled in the art, as well as the required conductive layer(s).

When the photothermographic materials are heat-developed as described below in a substantially water-free condition after, or simultaneously with, imagewise exposure, a silver image (preferably a black-and-white silver image) is obtained.

Definitions

As used herein:

in the descriptions of the photothermographic materials, “a” or “an” component refers to “at least one” of that component (for example, the specific toners described herein).

Unless otherwise indicated, when the term “photothermographic materials” is used herein, the term refers to materials of the present invention.

Heating in a substantially water-free condition as used herein, means heating at a temperature of from about 50° C. to about 250° C. with little more than ambient water vapor present. The term “substantially water-free condition” means that the reaction system is approximately in equilibrium with water in the air and water for inducing or promoting the reaction is not particularly or positively supplied from the exterior to the material. Such a condition is described in T. H. James, The Theory of the Photographic Process, Fourth Edition, Eastman Kodak Company, Rochester, N.Y., 1977, p. 374.

“Photothermographic material(s)” means a construction comprising a support and at least one photothermographic emulsion layer or a photothermo-graphic set of emulsion layers, wherein the photosensitive silver halide and the source of reducible silver ions are in one layer and the other necessary components or additives are distributed, as desired, in the same layer or in an adjacent coated layer. These materials also include multilayer constructions in which one or more imaging components are in different layers, but are in “reactive association.” For example, one layer can include the non-photosensitive source of reducible silver ions and another layer can include the reducing composition, but the two reactive components are in reactive association with each other.

When used in photothermography, the term, “imagewise exposing” or “imagewise exposure” means that the material is imaged using any exposure means that provides a latent image using electromagnetic radiation. This includes, for example, by analog exposure where an image is formed by projection onto the photosensitive material as well as by digital exposure where the image is formed one pixel at a time such as by modulation of scanning laser radiation.

“Catalytic proximity” or “reactive association” means that the reactive components are in the same layer or in adjacent layers so that they readily come into contact with each other during imaging and thermal development.

“Emulsion layer,” “imaging layer,” or “photothermographic emulsion layer” means a layer of a photothermographic material that contains the photosensitive silver halide and/or non-photosensitive source of reducible silver ions, or a reducing composition. Such layers can also contain additional components or desirable additives. These layers are usually on what is known as the “frontside” of the support, but they can also be on both sides of the support.

“Photocatalyst” means a photosensitive compound such as silver halide that, upon exposure to radiation, provides a compound that is capable of acting as a catalyst for the subsequent development of the image-forming material.

Many of the chemical components used herein are provided as a solution. The term “active ingredient” means the amount or the percentage of the desired chemical component contained in a sample. All amounts listed herein are the amount of active ingredient added unless otherwise specified.

“Ultraviolet region of the spectrum” refers to that region of the spectrum less than or equal to 410 nm (preferably from about 100 nm to about 410 nm) although parts of these ranges may be visible to the naked human eye.

“Visible region of the spectrum” refers to that region of the spectrum of from about 400 nm to about 700 nm.

“Short wavelength visible region of the spectrum” refers to that region of the spectrum of from about 400 nm to about 450 nm.

“Red region of the spectrum” refers to that region of the spectrum of from about 600 nm to about 700 nm.

“Infrared region of the spectrum” refers to that region of the spectrum of from about 700 nm to about 1400 nm.

“Non-photosensitive” means not intentionally light sensitive.

The sensitometric terms “photospeed,” “speed,” or “photographic speed” (also known as sensitivity), absorbance, and contrast have conventional definitions known in the imaging arts. The sensitometric term absorbance is another term for optical density (OD).

In photothermographic materials, the term Dₘᵢₙ (lower case) is considered herein as image density achieved when the photothermographic material is thermally developed without prior exposure to radiation. The term Dₘₐₓ (lower case) is the maximum image density achieved in the imaged area of a particular sample after imaging and development.

The term D_{MIN} (upper case) is the density of the nonimaged, undeveloped material. The term D_{MAX} (upper case) is the maximum image density achievable when the photothermographic material is exposed and then thermally developed. D_{MAX} is also known as “Saturation Density.”

“Transparent” means capable of transmitting visible light or imaging radiation without appreciable scattering or absorption.

As used herein, the phrase “silver organic coordinating ligand” refers to an organic molecule capable of forming a bond with a silver atom. Although the compounds so formed are technically silver coordination compounds they are also often referred to as silver salts.

The terms “coating weight,” “coat weight,” and “coverage” are synonymous, and are usually expressed in weight per unit area such as g/m².

As is well understood in this art, for the chemical compounds herein described, substitution is not only tolerated, but is often advisable and various substituents are anticipated on the compounds used in the present invention unless otherwise stated. Thus, when a compound is referred to as “having the structure” of a given formula or being a “derivative” of a compound, any substitution that does not alter the bond structure of the formula or the shown atoms within that structure is included within the formula, unless such substitution is specifically excluded by language.

As a means of simplifying the discussion and recitation of certain substituent groups, the term “group” refers to chemical species that may be substituted as well as those that are not so substituted. Thus, the term “alkyl group” is intended to include not only pure hydrocarbon alkyl chains, such as methyl, ethyl, n-propyl, t-butyl, cyclohexyl, iso-octyl, and octadecyl, but also alkyl chains bearing substituents known in the art, such as hydroxyl, alkoxy, phenyl, halogen atoms (F, Cl, Br, and I), cyano, nitro, amino, and carboxy. For example, alkyl group includes ether and thioether groups (for example CH₃—CH₂—CH₂—O—CH₂— and CH₃—CH₂—CH₂—S—CH₂—), haloalkyl, nitroalkyl, alkylcarboxy, carboxyalkyl, carboxamido, hydroxyalkyl, sulfoalkyl, and other groups readily apparent to one skilled in the art. Substituents that adversely react with other active ingredients, such as very strongly electrophilic or oxidizing substituents, would, of course, be excluded by the skilled artisan as not being inert or harmless.

Research Disclosure is a publication of Kenneth Mason Publications Ltd., Dudley House, 12 North Street, Emsworth, Hampshire PO10 7DQ England. It is also available from Emsworth Design Inc., 147 West 24th Street, New York, N.Y. 10011.

Other aspects, advantages, and benefits of the present invention are apparent from the detailed description, examples, and claims provided in this application.

The Photocatalyst

As noted above, photothermographic materials include one or more photocatalysts in the photothermographic emulsion layer(s). Useful photocatalysts are typically photosensitive silver halides such as silver bromide, silver iodide, silver chloride, silver bromoiodide, silver chlorobromoiodide, silver chlorobromide, and others readily apparent to one skilled in the art. Mixtures of silver halides can also be used in any suitable proportion. Silver bromide and silver bromoiodide are more preferred, with the latter silver halide generally having up to 10 mol % silver iodide.

In some embodiments of aqueous-based photothermographic materials, higher amounts of iodide may be present in homogeneous photosensitive silver halide grains, and particularly from about 20 mol % up to the saturation limit of iodide as described, for example, U.S. patent application Publication 2004/0053173 (Maskasky et al.).

The silver halide grains may have any crystalline habit or morphology including, but not limited to, cubic, octahedral, tetrahedral, orthorhombic, rhombic, dodecahedral, other polyhedral, tabular, laminar, twinned, or platelet morphologies and may have epitaxial growth of crystals thereon. If desired, a mixture of grains with different morphologies can be employed. Silver halide grains having cubic and tabular morphology (or both) are preferred.

The silver halide grains may have a uniform ratio of halide throughout. They may also have a graded halide content, with a continuously varying ratio of, for example, silver bromide and silver iodide or they may be of the core-shell type, having a discrete core of one or more silver halides, and a discrete shell of one or more different silver halides. Core-shell silver halide grains useful in photothermographic materials and methods of preparing these materials are described in U.S. Pat. No. 5,382,504 (Shor et al.), incorporated herein by reference. Iridium and/or copper doped core-shell and non-core-shell grains are described in U.S. Pat. No. 5,434,043 (Zou et al.) and U.S. Pat. No. 5,939,249 (Zou), both incorporated herein by reference.

In some instances, it may be helpful to prepare the photosensitive silver halide grains in the presence of a hydroxytetrazaindene (such as 4-hydroxy-6-methyl-1,3,3a,7-tetrazaindene) or an N-heterocyclic compound comprising at least one mercapto group (such as 1-phenyl-5-mercaptotetrazole) as described in U.S. Pat. No. 6,413,710 (Shor et al.) that is incorporated herein by reference.

The photosensitive silver halide can be added to (or formed within) the emulsion layer(s) in any fashion as long as it is placed in catalytic proximity to the non-photosensitive source of reducible silver ions.

It is preferred that the silver halides be preformed and prepared by an ex-situ process. With this technique, one has the possibility of more precisely controlling the grain size, grain size distribution, dopant levels, and composition of the silver halide, so that one can impart more specific properties to both the silver halide grains and the resulting photothermographic material.

In some constructions, it is preferable to form the non-photo-sensitive source of reducible silver ions in the presence of ex-situ-prepared silver halide. In this process, the source of reducible silver ions, such as a long chain fatty acid silver carboxylate (commonly referred to as a silver “soap”), is formed in the presence of the preformed silver halide grains. Co-precipitation of the source of reducible silver ions in the presence of silver halide provides a more intimate mixture of the two materials to provide a material often referred to as a “preformed soap” [see U.S. Pat. No. 3,839,049 (Simons)].

In some constructions, it is preferred that preformed silver halide grains be added to and “physically mixed” with the non-photosensitive source of reducible silver ions.

Preformed silver halide emulsions can be prepared by aqueous or organic processes and can be unwashed or washed to remove soluble salts. Soluble salts can be removed by any desired procedure for example as described in U.S. Pat. No. 2,618,556 (Hewitson et al.), U.S. Pat. No. 2,614,928 (Yutzy et al.), U.S. Pat. No. 2,565,418 (Yackel), U.S. Pat. No. 3,241,969 (Hart et al.), and U.S. Pat. No. 2,489,341 (Waller et al.).

It is also effective to use an in-situ process in which a halide- or a halogen-containing compound is added to an organic silver salt to partially convert the silver of the organic silver salt to silver halide. Inorganic halides (such as zinc bromide, zinc iodide, calcium bromide, lithium bromide, lithium iodide, or mixtures thereof) or an organic halogen-containing compound (such as N-bromo-succinimide or pyridinium hydrobromide perbromide) can be used. The details of such in-situ generation of silver halide are well known and described in U.S. Pat. No. 3,457,075 (Morgan et al.).

It is particularly effective to use a mixture of both preformed and in-situ generated silver halide. The preformed silver halide is preferably present in a preformed soap.

Additional methods of preparing silver halides and organic silver salts and blending them are described in Research Disclosure, June 1978, item 17029, U.S. Pat. No. 3,700,458 (Lindholm) and U.S. Pat. No. 4,076,539 (Ikenoue et al.), Japanese Kokai 49-013224 (Fuji), 50-017216 (Fuji), and 51-042529 (Fuji).

The silver halide grains used in the imaging formulations can vary in average diameter of up to several micrometers (μm) depending on the desired use. Preferred silver halide grains are those having an average particle size of from about 0.01 to about 1 μm, more preferred are those having an average particle size of from about 0.01 to about 0.1 μm, and most preferred are those having an average particle size of from about 0.01 to about 0.06 μm.

The average size of the photosensitive silver halide grains is expressed by the average diameter if the grains are spherical, and by the average of the diameters of equivalent circles for the projected images if the grains are cubic or in other non-spherical shapes. Representative grain sizing methods are described in Particle Size Analysis, ASTM Symposium on Light Microscopy, R. P. Loveland, 1955, pp. 94-122, and in C. E. K. Mees and T. H. James, The Theory of the Photographic Process, Third Edition, Macmillan, New York, 1966, Chapter 2. Particle size measurements may be expressed in terms of the projected areas of grains or approximations of their diameters. These will provide reasonably accurate results if the grains of interest are substantially uniform in shape.

The one or more light-sensitive silver halides are preferably present in an amount of from about 0.005 to about 0.5 mole, more preferably from about 0.01 to about 0.25 mole, and most preferably from about 0.03 to about 0.15 mole, per mole of non-photosensitive source of reducible silver ions.

Chemical Sensitization

The photosensitive silver halides can be chemically sensitized using any useful compound that contains sulfur, tellurium, or selenium, or may comprise a compound containing gold, platinum, palladium, ruthenium, rhodium, iridium, or combinations thereof, a reducing agent such as a tin halide or a combination of any of these. The details of these materials are provided for example, in T. H. James, The Theory of the Photographic Process, Fourth Edition, Eastman Kodak Company, Rochester, N.Y., 1977, Chapter 5, pp. 149-169. Suitable conventional chemical sensitization procedures are also described in U.S. Pat. No. 1,623,499 (Sheppard et al.), U.S. Pat. No. 2,399,083 (Waller et al.), U.S. Pat. No. 3,297,447 (McVeigh), U.S. Pat. No. 3,297,446 (Dunn), U.S. Pat. No. 5,049,485 (Deaton), 5,252,455 (Deaton), U.S. Pat. No. 5,391,727 (Deaton), U.S. Pat. No. 5,912,111 (Lok et al.), and U.S. Pat. No. 5,759,761 (Lushington et al.), and EP 0 915 371A1 (Lok et al.), all of which are incorporated herein by reference.

Mercaptotetrazoles and tetraazindenes as described in U.S. Pat. No. 5,691,127 (Daubendiek et al.), incorporated herein by reference, can also be used as suitable addenda for tabular silver halide grains.

Certain substituted and unsubstituted thiourea compounds can be used as chemical sensitizers including those described in U.S. Pat. No. 6,368,779 (Lynch et al.) that is incorporated herein by reference.

Still other additional chemical sensitizers include certain tellurium-containing compounds that are described in U.S. Pat. No. 6,699,647 (Lynch et al.), and certain selenium-containing compounds that are described in U.S. Pat. No. 6,620,577 (Lynch et al.), that are both incorporated herein by reference.

Combinations of gold (3+)-containing compounds and either sulfur-, tellurium-, or selenium-containing compounds are also useful as chemical sensitizers as described in U.S. Pat. No. 6,423,481 (Simpson et al.) that is also incorporated herein by reference.

In addition, sulfur-containing compounds can be decomposed on silver halide grains in an oxidizing environment according to the teaching in U.S. Pat. No. 5,891,615 (Winslow et al.). Examples of sulfur-containing compounds that can be used in this fashion include sulfur-containing spectral sensitizing dyes.

Other useful sulfur-containing chemical sensitizing compounds that can be decomposed in an oxidized environment are the diphenylphosphine sulfide compounds represented by Structure (PS) described in copending and commonly assigned U.S. Ser. No. 10/731,251 (filed Dec. 9, 2003 by Simpson, Burleva, and Sakizadeh) which application is incorporated herein by reference.

The chemical sensitizers can be present in conventional amounts that generally depend upon the average size of the silver halide grains. Generally, the total amount is at least 10⁻¹⁰ mole per mole of total silver, and preferably from about 10⁻⁸ to about 10⁻² mole per mole of total silver for silver halide grains having an average size of from about 0.01 to about 2 μm.

Spectral Sensitization

The photosensitive silver halides may be spectrally sensitized with one or more spectral sensitizing dyes that are known to enhance silver halide sensitivity to ultraviolet, visible, and/or infrared radiation. IR sensitivity is particularly useful. Non-limiting examples of spectral sensitizing dyes that can be employed include cyanine dyes, merocyanine dyes, complex cyanine dyes, complex merocyanine dyes, holopolar cyanine dyes, hemicyanine dyes, styryl dyes, and hemioxanol dyes. They may be added at any stage in chemical finishing of the photothermographic emulsion, but are generally added after chemical sensitization is achieved.

Suitable spectral sensitizing dyes such as those described in U.S. Pat. No. 3,719,495 (Lea), U.S. Pat. No. 4,396,712 (Kinoshita et al.), U.S. Pat. No.4,439,520 (Kofron et al.), U.S. Pat. No. 4,690,883 (Kubodera et al.), U.S. Pat. No. 4,840,882 (Iwagaki et al.), U.S. Pat. No. 5,064,753 (Kohno et al.), U.S. Pat. No. 5,281,515 (Delprato et al.), U.S. Pat. No. 5,393,654 (Burrows et al.), U.S. Pat. No. 5,441,866 (Miller et al.), U.S. Pat. No. 5,508,162 (Dankosh), U.S. Pat. No. 5,510,236 (Dankosh), and U.S. Pat. No. 5,541,054 (Miller et al.), and Japanese Kokai 2000-063690 (Tanaka et al.), 2000-112054 (Fukusaka et al.), 2000-273329 (Tanaka et al.), 2001-005145 (Arai), 2001-064527 (Oshiyama et al.), and 2001-154305 (Kita et al.), can be used in the practice of the invention. All of the publications noted above are incorporated herein by reference. Useful spectral sensitizing dyes are also described in Research Disclosure, December 1989, item 308119, Section IV and Research Disclosure, 1994, item 36544, section V.

Teachings relating to specific combinations of spectral sensitizing dyes also include U.S. Pat. No. 4,581,329 (Sugimoto et al.), U.S. Pat. No. 4,582,786 (Ikeda et al.), U.S. Pat. No. 4,609,621 (Sugimoto et al.), U.S. Pat. No. 4,675,279 (Shuto et al.), U.S. Pat. No. 4,678,741 (Yamada et al.), U.S. Pat. No. 4,720,451 (Shuto et al.), U.S. Pat. No. 4,818,675 (Miyasaka et al.), U.S. Pat. No. 4,945,036 (Arai et al.), and U.S. Pat. No. 4,952,491 (Nishikawa et al.). All of the above publications and patents are incorporated herein by reference.

Also useful are spectral sensitizing dyes that decolorize by the action of light or heat as described in U.S. Pat. No. 4,524,128 (Edwards et al.), and Japanese Kokai 2001-109101 (Adachi), 2001-154305 (Kita et al.), and 2001-183770 (Hanyu et al.), all incorporated herein by reference.

Dyes may be selected for the purpose of supersensitization to attain much higher sensitivity than the sum of sensitivities that can be achieved by using each dye alone.

An appropriate amount of spectral sensitizing dye added is generally about 10⁻¹⁰ to 10⁻¹ mole, and preferably, about 10⁻⁷ to 10⁻² mole per mole of silver halide.

Non-Photosensitive Source of Reducible Silver Ions

The non-photosensitive source of reducible silver ions in the photothermographic materials is a silver-organic compound that contains reducible silver (1+) ions. Such compounds are generally silver salts of silver organic coordinating ligands that are comparatively stable to light and form a silver image when heated to 50° C. or higher in the presence of an exposed photocatalyst (such as silver halide) and a reducing agent composition.

The primary organic silver salt is often a silver salt of an aliphatic carboxylate (described below). Mixtures of silver salts of aliphatic carboxylates are particularly useful where the mixture includes at least silver behenate.

Useful silver carboxylates include silver salts of long-chain aliphatic carboxylic acids. The aliphatic carboxylic acids generally have aliphatic chains that contain 10 to 30, and preferably 15 to 28, carbon atoms. Examples of such preferred silver salts include silver behenate, silver arachidate, silver stearate, silver oleate, silver laurate, silver caprate, silver myristate, silver palmitate, silver maleate, silver fumarate, silver tartarate, silver furoate, silver linoleate, silver butyrate, silver camphorate, and mixtures thereof. Most preferably, at least silver behenate is used alone or in mixtures with other silver carboxylates.

Silver salts other than the silver carboxylates described above can be used also. Such silver salts include silver salts of aliphatic carboxylic acids containing a thioether group as described in U.S. Pat. No. 3,330,663 (Weyde et al.), soluble silver carboxylates comprising hydrocarbon chains incorporating ether or thioether linkages or sterically hindered substitution in the α-(on a hydrocarbon group) or ortho- (on an aromatic group) position as described in U.S. Pat. No. 5,491,059 (Whitcomb), silver salts of dicarboxylic acids, silver salts of sulfonates as described in U.S. Pat. No. 4,504,575 (Lee), silver salts of sulfosuccinates as described in EP 0 227 141A1 (Leenders et al.), silver salts of aromatic carboxylic acids (such as silver benzoate), silver salts of acetylenes as described, for example in U.S. Pat. No. 4,761,361 (Ozaki et al.) and U.S. Pat. No. 4,775,613 (Hirai et al.), and silver salts of heterocyclic compounds containing mercapto or thione groups and derivatives as described in U.S. Pat. No. 4,123,274 (Knight et al.) and U.S. Pat. No. 3,785,830 (Sullivan et al.).

It is also convenient to use silver half soaps such as an equimolar blend of silver carboxylate and carboxylic acid that analyzes for about 14.5% by weight solids of silver in the blend and that is prepared by precipitation from an aqueous solution of an ammonium or an alkali metal salt of a commercially available fatty carboxylic acid, or by addition of the free fatty acid to the silver soap.

The methods used for making silver soap emulsions are well known in the art and are disclosed in Research Disclosure, April 1983, item 22812, Research Disclosure, October 1983, item 23419, U.S. Pat. No. 3,985,565 (Gabrielsen et al.) and the references cited above.

Sources of non-photosensitive reducible silver ions can also be core-shell silver salts as described in U.S. Pat. No. 6,355,408. (Whitcomb et al.) that is incorporated herein by reference, wherein a core has one or more silver salts and a shell has one or more different silver salts, as long as one of the silver salts is a silver carboxylate.

Other useful sources of non-photosensitive reducible silver ions are the silver dimer compounds that comprise two different silver salts as described in U.S. Pat. No. 6,472,131 (Whitcomb) that is incorporated herein by reference.

Still other useful sources of non-photosensitive reducible silver ions are the silver core-shell compounds comprising a primary core comprising one or more photosensitive silver halides, or one or more non-photosensitive inorganic metal salts or non-silver containing organic salts, and a shell at least partially covering the primary core, wherein the shell comprises one or more non-photosensitive silver salts, each of which silver salts comprises a organic silver coordinating ligand. Such compounds are described in U.S. patent application Publication 2004/0023164 (Bokhonov et al.) that is incorporated herein by reference.

Organic silver salts that are particularly useful in organic solvent-based photothermographic materials include silver carboxylates (both aliphatic and aromatic carboxylates), silver triazolates, silver sulfonates, silver sulfo-succinates, and silver acetylides. Silver salts of long-chain aliphatic carboxylic acids containing 15 to 28 carbon atoms and silver salts are particularly preferred.

The one or more non-photosensitive sources of reducible silver ions are preferably present in an amount of from about 5% to about 70%, and more preferably from about 10% to about 50%, based on the total dry weight of the emulsion layers. Alternatively stated, the amount of the sources of reducible silver ions is generally from about 0.001 to about 0.2 mol/m² of the dry photothermographic material (preferably from about 0.01 to about 0.05 mol/m²).

The total amount of silver (from all silver sources) in the photothermographic materials is generally at least 0.002 mol/m², preferably from at least 0.01 to about 0.05 mol/m², and more preferably from about 0.01 to about 0.02 mol/m².

Reducing Agents

The reducing agent (or reducing agent composition comprising two or more components) for the source of reducible silver ions can be any material (preferably an organic material) that can reduce silver (1+) ion to metallic silver. The “reducing agent” is sometimes called a “developer” or “developing agent.”

When a silver carboxylate silver source is used in a photothermo-graphic material, one or more hindered phenol or o-bisphenol reducing agents are preferred. In some instances, the reducing agent composition comprises two or more components such as a hindered phenol or o-bisphenol developer and a co-developer that can be chosen from the various classes of co-developers and reducing agents described below. Ternary developer mixtures involving the further addition of contrast enhancing agents are also useful. Such contrast enhancing agents can be chosen from the various classes of reducing agents described below.

“Hindered phenol reducing agents” are compounds that contain only one hydroxy group on a given phenyl ring and have at least one additional substituent located ortho to the hydroxy group. Hindered phenols include hindered phenols and hindered naphthols.

Another type of hindered phenol reducing agent are hindered bis-phenols. These compounds contain more than one hydroxy group each of which is located on a different phenyl ring. This type of hindered phenol includes, for example, binaphthols (that is dihydroxybinaphthyls), biphenols (that is dihydroxybiphenyls), bis(hydroxynaphthyl)methanes, bis(hydroxy-phenyl)methanes bis(hydroxyphenyl)ethers, and bis(hydroxypehnyl)thioethers, each of which may have additional substituents.

Particularly useful reducing agents are the hindered bis-phenol compounds represented by the following Structure (III):

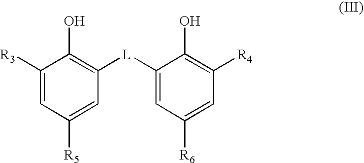

In Structure III, R₃ and R₄ each independently represents a substituted or unsubstituted linear, branched, or cyclic alkyl group having 1 to 20 carbon atoms. Preferably, R₃ and R₄ each independently represent a substituted or unsubstituted linear, branched, or cyclic alkyl group having 3 to 7 carbon atoms, such as an isopropyl group, isobutyl group, tert-butyl group, tert-amyl group, or methylcyclohexyl group.

R₅ and R₆ each independently represents hydrogen or a monovalent substituent such as an alkyl group, aryl group, halogen atom, or alkoxy group. Preferably, R₅ and R₆ each independently represent a substituted or unsubstituted linear, branched, or cyclic alkyl group having 1 to 20 carbon atoms. More preferably R₅ and R₆ each independently represent a substituted or unsubstituted linear, branched, or cyclic alkyl group having 1 to 10 carbon atoms, such as a methyl group, ethyl group, propyl group, isopropyl group, isobutyl group, tert-butyl group, or tert-amyl group.

L represents —S— or —CHR₇ in which R₇ represents a hydrogen atom or a substituted or unsubstituted linear, branched, or cyclic alkyl group having 1 to 20 carbon atoms. Preferably, L is a —CHR₇— group wherein R₇ represents a substituted or unsubstituted linear, branched, or cyclic alkyl group having 1 to 10 carbon atoms. More preferably, R₇ represents a linear or branched alkyl group having 1 to 10 carbon atoms, such as methyl, ethyl, propyl, isopropyl, isobutyl, tert-butyl, tert-amyl, heptyl, or 2,2,4-trimethylhexyl. Examples of such unsubstituted alkyl groups include a methyl group, ethyl group, propyl group, isopropyl group, butyl group, 1 -ethylpentyl group, 2,4,4-trimethylpentyl group, and 3,5,5-trimethylhexyl group.

Particularly useful hindered bisphenol reducing agents represented by Structure III include bis(hydroxyphenyl)methanes such as, 1,1′-bis(2-hydroxy-3-t-butyl-5-methylphenyl)methane (CAO-5), 1,1′-bis(2-hydroxy-3,5-dimethyl-phenyl)-3,5,5-trimethylhexane (NONOX® or PERMANAX WSO), and 1,1′-bis(2-hydroxy-3,5-dimethyl)isobutane (LOWINOX® 22IB46) Mixtures of hindered phenol reducing agents can be used if desired. 1,1′-Bis(2-hydroxy-3,5-dimethyl)isobutane (LOWINOX® 22IB46) is most preferred. Mixtures of reducing agents can also be used if desired.

An additional class of reducing agents that can be used are substituted hydrazines including the sulfonyl hydrazides described in U.S. Pat. No. 5,464,738 (Lynch et al.). Still other useful reducing agents are described in U.S. Pat. No. 3,074,809 (Owen), U.S. Pat. No. 3,094,417 (Workman), U.S. Pat. No. 3,080,254 (Grant, Jr.), U.S. Pat. No. 3,887,417 (Klein et al.), and U.S. Pat. No. 5,981,151 (Leenders et al.). All of these patents are incorporated herein by reference.

Additional reducing agents that may be used include amidoximes, azines, a combination of aliphatic carboxylic acid aryl hydrazides and ascorbic acid, a reductone and/or a hydrazine, piperidinohexose reductone or formyl-4-methylphenylhydrazine, hydroxamic acids, a combination of azines and sulfonamidophenols, α-cyanophenylacetic acid derivatives, reductones, indane-1,3-diones, chromans, 1,4-dihydropyridines, and 3-pyrazolidones.

Useful co-developer reducing agents can also be used as described in U.S. Pat. No. 6,387,605 (Lynch et al.) that is incorporated herein by reference. Additional classes of reducing agents that can be used as co-developers are trityl hydrazides and formyl phenyl hydrazides as described in U.S. Pat. No. 5,496,695 (Simpson et al.), 2-substituted malondialdehyde compounds as described in U.S. Pat. No. 5,654,130 (Murray), and 4-substituted isoxazole compounds as described in U.S. Pat. No. 5,705,324 (Murray). Additional developers are described in U.S. Pat. No. 6,100,022 (Inoue et al.). All of the patents above are incorporated herein by reference. Yet another class of co-developers includes substituted acrylonitrile compounds such as the compounds identified as HET-01 and HET-02 in U.S. Pat. No. 5,635,339 (Murray) and CN-01 through CN-13 in U.S. Pat. No. 5,545,515 (Murray et al.).

Various contrast enhancing agents can be used in some photothermographic materials with specific co-developers. Examples of useful contrast enhancing agents include, but are not limited to, hydroxylamines, alkanolamines and ammonium phthalamate compounds as described in U.S. Pat. No. 5,545,505 (Simpson), hydroxamic acid compounds as described for example, in U.S. Pat. No. 5,545,507 (Simpson et al.), N-acylhydrazine compounds as described in U.S. Pat. No. 5,558,983 (Simpson et al.), and hydrogen atom donor compounds as described in U.S. Pat. No. 5,637,449 (Harring et al.). All of the patents above are incorporated herein by reference.

The reducing agent (or mixture thereof) described herein (particularly those represented by Structure III above) is present in an amount of at least 0.10 and up to and including 0.32 mol/mol of total silver, and preferably in an amount of from about 0.10 to about 0.25 mol/mol of total silver. Co-developers may be present generally in an amount of from about 0.001% to about 1.5% (dry weight) of the emulsion layer coating.

Other Addenda

The photothermographic materials can also contain other additives such as shelf-life stabilizers, antifoggants, contrast enhancers, development accelerators, acutance dyes, post-processing stabilizers or stabilizer precursors, thermal solvents (also known as melt formers), and other image-modifying agents as would be readily apparent to one skilled in the art.

To further control the properties of photothermographic materials, (for example, contrast, Dₘᵢₙ, speed, or fog), it may be preferable to add one or more heteroaromatic mercapto compounds or heteroaromatic disulfide compounds of the formulae Ar—S-M¹ and Ar—S—S—Ar, wherein M¹ represents a hydrogen atom or an alkali metal atom and Ar represents a heteroaromatic ring or fused hetero-aromatic ring containing one or more of nitrogen, sulfur, oxygen, selenium, or tellurium atoms. Preferably, the heteroaromatic ring comprises benzimidazole, naphthimidazole, benzothiazole, naphthothiazole, benzoxazole, naphthoxazole, benzoselenazole, benzotellurazole, imidazole, oxazole, pyrazole, triazole, thiazole, thiadiazole, tetrazole, triazine, pyrimidine, pyridazine, pyrazine, pyridine, purine, quinoline, or quinazolinone. Useful heteroaromatic mercapto compounds are described as supersensitizers for infrared photothermographic materials in EP 0 559 228B1 (Philip Jr. et al.).

Heteroaromatic mercapto compounds are most preferred. Examples of preferred heteroaromatic mercapto compounds are 2-mercaptobenz-imidazole, 2-mercapto-5-methylbenzimidazole, 2-mercaptobenzothiazole and 2-mercaptobenzoxazole, and mixtures thereof.

A heteroaromatic mercapto compound is generally present in an emulsion layer in an amount of at least 0.0001 mole (preferably from about 0.001 to about 1.0 mole) per mole of total silver in the emulsion layer.

The photothermographic materials can be further protected against the production of fog and can be stabilized against loss of sensitivity during storage. Suitable antifoggants and stabilizers that can be used alone or in combination include thiazolium salts as described in U.S. Pat. No. 2,131,038 (Brooker) and U.S. Pat. No. 2,694,716 (Allen), azaindenes as described in U.S. Pat. No. 2,886,437 (Piper), triazaindolizines as described in U.S. Pat. No. 2,444,605 (Heimbach), urazoles as described in U.S. Pat. No. 3,287,135 (Anderson), sulfocatechols as described in U.S. Pat. No. 3,235,652 (Kennard), the oximes described in GB 623,448 (Carrol et al.), polyvalent metal salts as described in U.S. Pat. No. 2,839,405 (Jones), thiuronium salts as described in U.S. Pat. No. 3,220,839 (Herz), palladium, platinum, and gold salts as described in U.S. Pat. No. 2,566,263 (Trirelli) and U.S. Pat. No. 2,597,915 (Damshroder).

Preferably, the photothermographic materials include one or more polyhalo antifoggants that contain one or more polyhalo substituents including but not limited to, dichloro, dibromo, trichloro, and tribromo groups. The antifoggants can be aliphatic, alicyclic or aromatic compounds, including aromatic heterocyclic and carbocyclic compounds. Particularly useful antifoggants are polyhalo antifoggants, such as those having a —SO₂C(X′)₃ group wherein X′ represents the same or different halogen atoms. Preferred compounds are those having —SO₂CBr₃ groups as described in U.S. Pat. No. 5,374,514 (Kirk et al.), U.S. Pat. No. 5,460,938 (Kirk et al.), and U.S. Pat. No. 5,594,143 (Kirk et al.). Non-limiting examples of such compounds include, 2-tribromomethylsulfonyl quinoline, 2-tribromomethyl-sulfonyl pyridine, tribromomethylbenzene, and substituted derivatives of these compounds. If present, these polyhalo antifoggants are present in an amount of at least 0.005 mol/mol of total silver, preferably in an amount of from about 0.02 to about 0.10 mol/mol of total silver, and more preferably in an amount of from 0.029 to 0.10 mol/mol of total silver.

Stabilizer precursor compounds capable of releasing stabilizers upon application of heat during development can also be used as described in U.S. Pat. No. 5,158,866 (Simpson et al.), U.S. Pat. No. 5,175,081 (Krepski et al.), U.S. Pat. No. 5,298,390 (Sakizadeh et al.), and U.S. Pat. No. 5,300,420 (Kenney et al.).

Benzotriazole compounds are preferred as image stabilizing compounds and are generally present in an amount of from about 0.005 to about 0.20 mol/mol of total silver. In materials where the development time is less than 13 seconds, the benzotriazole compounds are preferably present in an amount less than about 0.022 mol/mol of total silver. In addition, certain substituted-sulfonyl derivatives of benzotriazoles (for example alkylsulfonylbenzotriazoles and arylsulfonylbenzotriazoles) may be useful as described in U.S. Pat. No. 6,171,767 (Kong et al.). In some embodiments, the benzotriazoles are absent from the photothermographic materials.

Other useful antifoggants/stabilizers are described in U.S. Pat. No. 6,083,681 (Lynch et al.). Still other antifoggants are hydrobromic acid salts of heterocyclic compounds (such as pyridinium hydrobromide perbromide) as described in U.S. Pat. No. 5,028,523 (Skoug), benzoyl acid compounds as described in U.S. Pat. No. 4,784,939 (Pham), substituted propenenitrile compounds as described in U.S. Pat. No. 5,686,228 (Murray et al.), silyl blocked compounds as described in U.S. Pat. No. 5,358,843 (Sakizadeh et al.), vinyl sulfones as described in U.S. Pat. No. 6,143,487 (Philip, Jr. et al.), diisocyanate compounds as described in EP 0 600 586A1 (Philip, Jr. et al.), and tribromomethylketones as described in EP 0 600 587A1 (Oliff et al.).

The photothermographic materials may also include one or more thermal solvents (or melt formers) such as disclosed in U.S. Pat. No. 3,438,776 (Yudelson), U.S. Pat. No. 5,250,386 (Aono et al.), U.S. Pat. No. 5,368,979 (Freedman et al.), U.S. Pat. No. 5,716,772 (Taguchi et al.), and U.S. Pat. No. 6,013,420 (Windender).

It is often advantageous to include a base-release agent or base precursor in photothermographic materials. Representative base-release agents or base precursors include guanidinium compounds and other compounds that are known to release a base but do not adversely affect photographic silver halide materials (such as phenylsulfonyl acetates) as described in U.S. Pat. No. 4,123,274 (Knight et al.).

The photothermographic materials can also include one or more image stabilizing compounds that are usually incorporated in a “backside” layer. Such compounds can include phthalazinone and phthalazinone derivatives, pyridazine and pyridazine derivatives, benzoxazine and benzoxazine derivatives, benzothiazine dione and benzothiazine dione derivatives, and quinazoline dione and its quinazoline dione derivatives, particularly as described in U.S. Pat. No. 6,599,685 (Kong). Other useful backside image stabilizers include anthracene compounds, coumarin compounds, benzophenone compounds, benzotriazole compounds, naphthalic acid imide compounds, pyrazoline compounds, or compounds described in U.S. Pat. No. 6,465,162 (Kong et al), and GB 1,565,043 (Fuji Photo). All of these patents and patent applications are incorporated herein by reference. Benzotriazole compounds are preferred as backside image stabilizing compounds.

Phosphors are materials that emit infrared, visible, or ultraviolet radiation upon excitation and can be incorporated into the photothermographic materials. Particularly useful phosphors are sensitive to X-radiation and emit radiation primarily in the ultraviolet, near-ultraviolet, or visible regions of the spectrum (that is, from about 100 to about 700 nm). An intrinsic phosphor is a material that is naturally (that is, intrinsically) phosphorescent. An “activated” phosphor is one composed of a basic material that may or may not be an intrinsic phosphor, to which one or more dopant(s) has been intentionally added. These dopants or activators “activate” the phosphor and cause it to emit ultraviolet or visible radiation. Multiple dopants may be used and thus the phosphor would include both “activators” and “co-activators.”

Any conventional or useful phosphor can be used, singly or in mixtures. For example, useful phosphors are described in numerous references relating to fluorescent intensifying screens as well as U.S. Pat. No. 6,440,649 (Simpson et al.) and U.S. Pat. No. 6,573,033 (Simpson et al.) that are directed to photothermographic materials, both of which references are incorporated herein.

Some particularly useful phosphors are primarily “activated” phosphors known as phosphate phosphors and borate phosphors. Examples of these phosphors are rare earth phosphates, yttrium phosphates, strontium phosphates, or strontium fluoroborates (including cerium activated rare earth or yttrium phosphates, or europium activated strontium fluoroborates) as described in U.S. Ser. No. 10/826,500 (filed Apr. 16, 2004 by Simpson, Sieber, and Hansen).

The one or more phosphors can be present in the photothermo-graphic materials in an amount of at least 0.1 mole per mole, and preferably from about 0.5 to about 20 mole, per mole of total silver in the photothermographic material. As noted above, generally, the amount of total silver is at least 0.002 mol/m². While the phosphors can be incorporated into any imaging layer on one or both sides of the support, it is preferred that they be in the same layer(s) as the photosensitive silver halide(s) on one or both sides of the support.

“Toners” or derivatives thereof that improve the image are included within of the photothermographic materials. Toners (also known as “toning agents”) are compounds that when added to the imaging layer(s) shift the color of the developed silver image from yellowish-orange to brown-black or blue-black. Toners may be incorporated in the photothermographic emulsion layer(s) or in an adjacent non-imaging layer.

Compounds useful as toners are described in U.S. Pat. No. 3,080,254 (Grant, Jr.), U.S. Pat. No. 3,847,612 (Winslow), U.S. Pat. No. 4,123,282 (Winslow), U.S. Pat. No. 4,082,901 (Laridon et al.), U.S. Pat. No. 3,074,809 (Owen), U.S. Pat. No. 3,446,648 (Workman), U.S. Pat. No. 3,844,797 (Willems et al.), U.S. Pat. No. 3,951,660 (Hagemann et al.), U.S. Pat. No. 5,599,647 (Defieuw et al.) and GB 1,439,478 (AGFA).

Phthalazine and phthalazine derivatives [such as those described in U.S. Pat. No. 6,146,822 (Asanuma et al.), incorporated herein by reference], phthalazinone, and phthalazinone derivatives are particularly useful toners.

Additional useful toners are substituted and unsubstituted mercaptotriazoles as described in U.S. Pat. No. 3,832,186 (Masuda et al.), U.S. Pat. No. 6,165,704 (Miyake et al.), U.S. Pat. No. 5,149,620 (Simpson et al.), U.S. Pat. No. 6,713,240 (Lynch et al.), and U.S. patent application Publication 2004/0013984 (Lynch et al.), all of which are incorporated herein by reference.

Also useful are the phthalazine compounds described in U.S. Pat. No. 6,605,481 (Ramsden et al.), the triazine thione compounds described in U.S. Pat. No. 6,703,191 (Lynch et al.), and the heterocyclic disulfide compounds described in U.S. Pat. No. 6,737,227 (Lynch et al.), all of which are incorporated herein by reference.

The photothermographic materials contain a combination of specific toners to facilitate the shorter development times. Thus, they contain one or more compounds that are represented by Structure I shown below and one of more compounds represented by Structure II shown below.

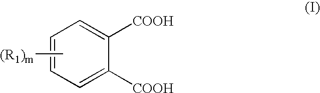

In Structure I, R₁ represents an alkyl group, aryl group, alkoxy group, aryloxy group, halo group, cyano group, or nitro group. In addition, m is 0 or an integer up to 4. When m is greater than or equal to 2, a plurality of R₁ groups may be the same or different, and when present, two or more R₁ groups may form a fused aliphatic, aromatic, or heterocyclic fused ring. When m is 4, all R₁ are not chloro.

Examples of substituents represented by R₁ include but are not limited to: alkyl groups having 1 to 20 carbon atoms, preferably having 1 to 8 carbon atoms (such as methyl, ethyl, n-propyl, iso-propyl, n-butyl, iso-butyl, tert-butyl, n-octyl, n-decyl, n-hexadecyl, cyclopropyl, cyclopentyl, and cyclohexyl), aryl groups having 6 to 30 carbon atoms, preferably having 6 to 12 carbon atoms,(such as phenyl, p-methylphenyl, and naphthyl), alkoxy groups having 1 to 20 carbon atoms, preferably having 1 to 8 carbon atoms (such as methoxy, ethoxy, and butoxy), aryloxy groups having 6 to 20 carbon atoms, preferably having 6 to 10 carbon atoms (such as phenyloxy and 2-naphthyloxy), halogen atoms (such as fluorine, chlorine, bromine and iodine), cyano groups, and nitro groups. All these substituents may be further substituted. Where there are two or more substituents, they may be identical or different.

Preferably, m is equal to 1 or 2, and most preferably, m is equal to 1.

Particularly useful compounds represented by Structure I include phthalic acid, 4-methyl phthalic acid, and 2,3-naphthalenedicarboxylic acid. 4-Methyl phthalic acid is most preferred.

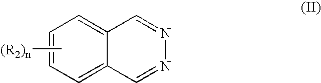

In Structure II, R₂ represents hydrogen or a substituent and n is 0 or an integer up to 4.

Examples of substituents represented by R₂ include but are not limited to: alkyl groups having 1 to 10 carbon atoms (such as substituted or unsubstituted methyl, ethyl, hydroxyrnethyl, t-butyl, n-hexyl, benzyl, and carboxymethyl groups), carbocyclic or heterocyclic aliphatic groups having 5 to 10 atoms in the ring (such as substituted or unsubstituted cyclopentyl, cyclohexyl, piperdinyl, morpholinyl, and thiotetrahydropyranyl groups), carbocyclic or heterocyclic aromatic groups having 5 to 10 atoms in the aromatic ring (such as substituted or unsubstituted phenyl, naphthyl, pyridinyl, thiazolyl, and furanyl groups), alkoxy groups, aryloxy groups, alkylthio groups, arylthio groups, alkyl (or aryl)—SO₂— groups, alkyl (or aryl)—SO— groups, —SO₃H, —SO₃⁻, halo (such as F, Cl, Br, and I), nitro, cyano, primary, secondary or tertiary amino groups, alkyl(or aryl)-(C═O)— groups, alkyl(or aryl)-(C═O)O— groups, alkyl(or aryl)-O(C═O)— group, and R″R′″N(C═O)—, or R″R″′NSO₂— groups, wherein R″ and R′″ are independently hydrogen, or substituted or unsubstituted alkyl or aryl groups. It will be understood that all of the above substituents may be further substituted.

Where more than one R₂ group is present, the R₂ groups can be the same or different. Further, where two or more R₂ groups are attached to the phthalazine ring, the two or more groups may form a substituted or unsubstituted carbocyclic or heterocyclic aliphatic or aromatic ring fused to the phthalazine nucleus (such as a substituted or unsubstituted benzo, pyridinyl, cyclohexyl, or dioxolanyl fused ring).

Preferably, R₂ is hydrogen or a substituted or unsubstituted alkyl group having from 1 to 10 carbon atoms, or substituted or unsubstituted phenyl group, and more preferably R₂ is hydrogen or a substituted or unsubstituted methyl, ethyl, propyl, iso-propyl, or butyl group. Most preferably, R₂ is hydrogen.

In Structure II, n is 0 or an integer up to 4. Preferably, n is 0 or 1.

Although Structure II is drawn as the free phthalazine molecule, in the present invention it is to be understood that Structure II also includes phthalazine salts of protic acids as represented by Structure II-a. Thus, X can be any non-reactive counterion, for example, chloride, tetrafluoroborate, perchlorate, tosylate, sulfate, and phosphate.

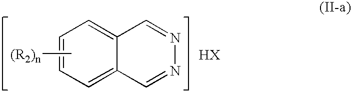

Particularly useful compounds represented by Structure II include phthalazine, phthalazine hydrochloride, and isopropyl phthalazine. Phthalazine is preferred.

The compounds represented by Structures I and II can be readily obtained from a number of commercial sources including Aldrich Chemical Co., or they can be prepared using known starting materials and reactants.

The amount of the one or more compounds represented by Structure I used in the photothermographic materials is at least 0.042 mol/mol of total silver, and preferably from about 0.042 to about 0.08 mol/mol of total silver. More preferably, the Structure I compound(s) is present in an amount of from about 0.053 to about 0.08 mol/mol of total silver.

The amount of the one or more compounds represented by Structure II used in the photothermographic materials is at least 0.10 mol/mol of total silver, and preferably from about 0.10 to about 0.2 mol/mol of total silver.

Binders

The photosensitive silver halide, the non-photosensitive source of reducible silver ions, the reducing agent composition, toners, and any other imaging layer additives are generally combined with one or more binders that are generally hydrophobic or hydrophilic in nature. Thus, either aqueous or organic solvent-based formulations can be used to prepare the photothermographic materials. Mixtures of either or both types of binders can also be used. It is preferred that the binder be selected from predominantly hydrophobic polymeric materials (at least 50 dry weight % of total binders).

Examples of typical hydrophobic binders include polyvinyl acetals, polyvinyl chloride, polyvinyl acetate, cellulose acetate, cellulose acetate butyrate, polyolefins, polyesters, polystyrenes, polyacrylonitrile, polycarbonates, methacrylate copolymers, maleic anhydride ester copolymers, butadiene-styrene copolymers, and other materials readily apparent to one skilled in the art. Copolymers (including terpolymers) are also included in the definition of polymers. The polyvinyl acetals (such as polyvinyl butyral and polyvinyl formal) and vinyl copolymers (such as polyvinyl acetate and polyvinyl chloride) are particularly preferred. Particularly suitable hydrophobic binders are polyvinyl butyral resins that are available under the names BUTVAR® (Solutia, Inc., St. Louis, Mo.) and PIOLOFORM® (Wacker Chemical Company, Adrian, Mich.).

Hydrophilic binders or water-dispersible polymeric latex polymers can also be present in the formulations. Examples of useful hydrophilic binders include, but are not limited to, proteins and protein derivatives, gelatin and gelatin-like derivatives (hardened or unhardened), cellulosic materials such as hydroxymethyl cellulose and cellulosic esters, acrylamide/methacrylamide polymers, acrylic/methacrylic polymers polyvinyl pyrrolidones, polyvinyl alcohols, poly(vinyl lactams), polymers of sulfoalkyl acrylate or methacrylates, hydrolyzed polyvinyl acetates, polyacrylamides, polysaccharides and other synthetic or naturally occurring vehicles commonly known for use in aqueous-based photographic emulsions (see for example, Research Disclosure, item 38957, noted above). Cationic starches can also be used as a peptizer for tabular silver halide grains as described in U.S. Pat. No. 5,620,840 (Maskasky) and U.S. Pat. No. 5,667,955 (Maskasky).

Hardeners for various binders may be present if desired. Useful hardeners are well known and include diisocyanate compounds as described in EP 0 600 586 B1 (Philip, Jr. et al.), vinyl sulfone compounds as described in U.S. Pat. No. 6,143,487 (Philip, Jr. et al.) and EP 0 640 589 A1 (Gathmann et al.), aldehydes and various other hardeners as described in U.S. Pat. No. 6,190,822 (Dickerson et al.). The hydrophilic binders used in the photothermographic materials are generally partially or fully hardened using any conventional hardener. Useful hardeners are well known and are described, for example, in T. H. James, The Theory of the Photographic Process, Fourth Edition, Eastman Kodak Company, Rochester, N.Y., 1977, Chapter 2, pp. 77-8.

Where the proportions and activities of the photothermographic materials require a particular developing time and temperature, the binder(s) should be able to withstand those conditions. When a hydrophobic binder is used, it is preferred that the binder (or mixture thereof) does not decompose or lose its structural integrity at 120° C. for 60 seconds. When a hydrophilic binder is used, it is preferred that the binder does not decompose or lose its structural integrity at 150° C. for 60 seconds. It is more preferred that it does not decompose or lose its structural integrity at 177° C. for 60 seconds.

The polymer binder(s) is used in an amount sufficient to carry the components dispersed therein. Preferably, a binder is used at a level of from about 10% to about 90% by weight (more preferably at a level of from about 20% to about 70% by weight) based on the total dry weight of the layer. It is particularly useful that the thermally developable materials include at least 50 weight % hydrophobic binders in both imaging and non-imaging layers on both sides of the support (and particularly the imaging side of the support).

Support Materials

The photothermographic materials comprise a polymeric support, that is preferably a flexible, transparent film that has any desired thickness and is composed of one or more polymeric materials. They are required to exhibit dimensional stability during thermal development and to have suitable adhesive properties with overlying layers. Useful polymeric materials for making such supports include polyesters [such as poly(ethylene terephthalate) and poly(ethylene naphthalate)], cellulose acetate and other cellulose esters, polyvinyl acetal, polyolefins, polycarbonates, and polystyrenes. Preferred supports are composed of polymers having good heat stability, such as polyesters and polycarbonates. Support materials may also be treated or annealed to reduce shrinkage and promote dimensional stability.

It is also useful to use supports comprising dichroic mirror layers as described in U.S. Pat. No. 5,795,708 (Boutet), incorporated herein by reference. Also useful are transparent, multilayer, polymeric supports comprising numerous alternating layers of at least two different polymeric materials as described in U.S. Pat. No. 6,630,283 (Simpson et al.), incorporated herein by reference.

Opaque supports can also be used, such as dyed polymeric films and resin-coated papers that are stable to high temperatures.

Support materials can contain various colorants, pigments, antihalation or acutance dyes if desired. For example, the support can include one or more dyes that provide a blue color in the resulting imaged film. Support materials may be treated using conventional procedures (such as corona discharge) to improve adhesion of overlying layers, or subbing or other adhesion-promoting layers can be used.

Photothermographic Formulations and Constructions

An organic solvent-based coating formulation for the photothermo-graphic emulsion layer(s) can be prepared by mixing the various components with one or more binders in a suitable organic solvent system that usually includes one or more solvents such as toluene, 2-butanone (methyl ethyl ketone), acetone, or tetrahydrofuran, or mixtures thereof.

Alternatively, the desired imaging components can be formulated with a hydrophilic binder (such as gelatin, a gelatin-derivative, or a latex) in water or water-organic solvent mixtures to provide aqueous-based coating formulations.

The photothermographic materials can contain plasticizers and lubricants such as poly(alcohols) and diols as described in U.S. Pat. No. 2,960,404 (Milton et al.), fatty acids or esters as described in U.S. Pat. No. 2,588,765 (Robijns) and U.S. Pat. No. 3,121,060 (Duane), and silicone resins as described in GB 955,061 (DuPont). The materials can also contain inorganic and organic matting agents as described in U.S. Pat. No. 2,992,101 (Jelley et al.) and U.S. Pat. No. 2,701,245 (Lynn). Polymeric fluorinated surfactants may also be useful in one or more layers as described in U.S. Pat. No. 5,468,603 (Kub).

U.S. Pat. No. 6,436,616 (Geisler et al.), incorporated herein by reference, describes various means of modifying photothermographic materials to reduce what is known as the “woodgrain” effect, or uneven optical density.

The photothermographic materials can include one or more antistatic agents in any of the layers on either or both sides of the support. Conductive components include soluble salts, evaporated metal layers, or ionic polymers as described in U.S. Pat. No. 2,861,056 (Minsk) and U.S. Pat. No. 3,206,312 (Sterman et al.), insoluble inorganic salts as described in U.S. Pat. No. 3,428,451 (Trevoy), electroconductive underlayers as described in U.S. Pat. No. 5,310,640 (Markin et al.), electronically-conductive metal antimonate particles as described in U.S. Pat. No. 5,368,995 (Christian et al.), and electrically-conductive metal-containing particles dispersed in a polymeric binder as described in EP 0 678 776 A1 (Melpolder et al.). Particularly useful conductive particles are the non-acicular metal antimonate particles described in U.S. Pat. No. 6,689,546 (LaBelle et al.). All of the above patents and patent applications are incorporated herein by reference.

It is particularly useful that the conductive layers be disposed on the backside of the support and especially where they are buried or underneath one or more other layers such as backside protective layer(s). Such backside conductive layers typically have a resistivity of about 10⁵ to about 10¹² ohm/sq as measured using a salt bridge water electrode resistivity measurement technique. This technique is described in R. A. Elder Resistivity Measurements on Buried Conductive Layers, EOS/ESD Symposium Proceedings, Lake Buena Vista, Fla., 1990, pp. 251-254, incorporated herein by reference. [EOS/ESD stands for Electrical Overstress/Electrostatic Discharge].

Still other conductive compositions include one or more fluoro-chemicals each of which is a reaction product of R_{f}—CH₂CH₂—SO₃H with an amine wherein R_{f} comprises 4 or more fully fluorinated carbon atoms as described in U.S. Pat. No. 6,699,648 (Sakizadeh et al.) that is incorporated herein by reference.

Additional conductive compositions include one or more fluoro-chemicals described in more detail in U.S. Pat. No. 6,762,013 (Sakizadeh et al.) that is incorporated herein by reference.

The photothermographic materials may also usefully include a magnetic recording material as described in Research Disclosure, Item 34390, November 1992, or a transparent magnetic recording layer such as a layer containing magnetic particles on the underside of a transparent support as described in U.S. Pat. No. 4,302,523 (Audran et al.), incorporated herein by reference.

To promote image sharpness, photothermographic materials can contain one or more layers containing acutance and/or antihalation dyes. These dyes are chosen to have absorption close to the exposure wavelength and are designed to absorb scattered light. One or more antihalation compositions may be incorporated into one or more antihalation backing layers, underlayers, or overcoats. Additionally, one or more acutance dyes may be incorporated into one or more frontside layers.

Dyes useful as antihalation and acutance dyes include squaraine dyes described in U.S. Pat. No. 5,380,635 (Gomez et al.) and U.S. Pat. No. 6,063,560 (Suzuki et al.), and EP 1 083 459A1 (Kimura), indolenine dyes described in EP 0 342 810A1 (Leichter), and cyanine dyes described in U.S. Pat. No. 6,689,547 (Hunt et al.), all incorporated herein by reference.

It may also be useful to employ compositions including acutance or antihalation dyes that will decolorize or bleach with heat during processing as described in U.S. Pat. No. 5,135,842 (Kitchin et al.), U.S. Pat. No. 5,266,452 (Kitchin et al.), U.S. Pat. No. 5,314,795 (Helland et al.), and U.S. Pat. No. 6,306,566, (Sakurada et al.), and Japanese Kokai 2001-142175 (Hanyu et al.) and 2001-183770 (Hanye et al.). Useful bleaching compositions are described in Japanese Kokai 11-302550 (Fujiwara), 2001-109101 (Adachi), 2001-51371 (Yabuki et al.), and 2000-029168 (Noro). All of the noted publications are incorporated herein by reference.

Other useful heat-bleachable backside antihalation compositions can include a radiation absorbing compound such as an oxonol dye and various other compounds used in combination with a hexaarylbiimidazole (also known as a “HABI”), or mixtures thereof. HABI compounds are described in U.S. Pat. No. 4,196,002 (Levinson et al.), U.S. Pat. No. 5,652,091 (Perry et al.), and U.S. Pat. No. 5,672,562 (Perry et al.), all incorporated herein by reference. Examples of such heat-bleachable compositions are described for example in U.S. Pat. No. 6,455,210 (Irving et al.), U.S. Pat. No. 6,514,677 (Ramsden et al.), and U.S. Pat. No. 6,558,880 (Goswami et al.), all incorporated herein by reference.

Under practical conditions of use, these compositions are heated to provide bleaching at a temperature of at least 90° C. for at least 0.5 seconds (preferably, at a temperature of from about 100° C. to about 200° C. for from about 5 to about 20 seconds).

It is preferable for the thermally developable imaging layers to have an optical density of at least 0.1 at the exposure wavelength. It is more preferable that the total optical density at the exposure wavelength of all layers on the imaging layer side of the support to be at least 0.6 and that the total optical density at the exposure wavelength for all layers on the backside (non-imaging) side of the support be at least 0.2.

The photothermographic formulations can be coated by various coating procedures including wire wound rod coating, dip coating, air knife coating, curtain coating, slide coating, or extrusion coating using hoppers of the type described in U.S. Pat. No. 2,681,294 (Beguin). Layers can be coated one at a time, or two or more layers can be coated simultaneously by the procedures described in U.S. Pat. No. 2,761,791 (Russell), U.S. Pat. No. 4,001,024 (Dittman et al.), U.S. Pat. No. 4,569,863 (Keopke et al.), U.S. Pat. No. 5,340,613 (Hanzalik et al.), U.S. Pat. No. 5,405,740 (LaBelle), U.S. Pat. No. 5,415,993 (Hanzalik et al.), U.S. Pat. No. 5,525,376 (Leonard), U.S. Pat. No. 5,733,608 (Kessel et al.), U.S. Pat. No. 5,849,363 (Yapel et al.), U.S. Pat. No. 5,843,530 (Jerry et al.), and U.S. Pat. No. 5,861,195 (Bhave et al.), and GB 837,095 (Ilford). A typical coating gap for the emulsion layer can be from about 10 to about 750 μm, and the layer can be dried in forced air at a temperature of from about 20° C. to about 100° C. It is preferred that the thickness of the layer be selected to provide maximum image densities greater than about 0.2, and more preferably, from about 0.5 to 5.0 or more, as measured by an X-rite Model 361/V Densitometer equipped with 301 Visual Optics, available from X-rite Corporation, (Granville, Mich.).

The photothermographic materials may also include a surface protective layer over the one or more emulsion layers. Layers to reduce emissions from the material may also be present, including the polymeric barrier layers described in U.S. Pat. No. 6,352,819 (Kenney et al.), U.S. Pat. No. 6,352,820 (Bauer et al.), U.S. Pat. No. 6,420,102 (Bauer et al.), U.S. Pat. No. 6,667,148 (Rao et al.), and U.S. Pat. No. 6,746,831 (Hunt), all incorporated herein by reference.

Preferably, two or more layer formulations are applied simultaneously to a support using slide coating, the first layer being coated on top of the second layer while the second layer is still wet. The first and second fluids used to coat these layers can be the same or different solvents.

For example, after or simultaneously with application of the emulsion formulation to the support, the surface protective layer can be applied over the emulsion formulation(s).

In other embodiments, a “carrier” layer formulation comprising a single-phase mixture of the two or more polymers described above may be applied directly onto the support and thereby located underneath the emulsion layer(s) as described in U.S. Pat. No. 6,355,405 (Ludemann et al.), incorporated herein by reference. The carrier layer formulation can be applied simultaneously with application of the emulsion layer formulation(s) and any overcoat or surface protective layers.

Mottle and other surface anomalies can be reduced in the materials by incorporation of a fluorinated polymer as described for example in U.S. Pat. No. 5,532,121 (Yonkoski et al.) or by using particular drying techniques as described, for example in U.S. Pat. No. 5,621,983 (Ludemann et al.).

While the first and second layers can be coated on one side of the film support, manufacturing methods can also include forming on the opposing or backside of the polymeric support, one or more additional layers, including a conductive layer, antihalation layer, or a layer containing a matting agent (such as silica), or a combination of such layers. Alternatively, one backside layer can perform all of the desired functions.

In a preferred construction, a conductive “carrier” layer formulation comprising a single-phase mixture of two or more polymers and non-acicular metal antimonate particles, may be applied directly onto the support and thereby be located underneath other backside layers. The carrier layer formulation can be applied simultaneously with application of these other backside layer formulations.

It is particularly contemplated that the photothermographic materials include emulsion layers on both sides of the support and/or an antihalation underlayer beneath at least one emulsion layer. Thus, the outermost protective layers described below can be disposed on both sides of the support.

Layers to promote adhesion of one layer to another are also known, as described in U.S. Pat. No. 5,891,610 (Bauer et al.), U.S. Pat. No. 5,804,365 (Bauer et al.), and U.S. Pat. No. 4,741,992 (Przezdziecki). Adhesion can also be promoted using specific polymeric adhesive materials as described in U.S. Pat. No. 5,928,857 (Geisler et al.).

Subsequently to or simultaneously with application of the emulsion formulation to the support, a protective overcoat formulation can be applied over the emulsion formulation.

Imaging/Development

The photothermographic materials can be imaged in any suitable manner by exposure using any suitable source of radiation to which they are sensitive, including X-radiation, ultraviolet radiation, visible light, near infrared radiation and infrared radiation to provide a latent image. Suitable exposure means are well known and include sources of radiation, including: incandescent or fluorescent lamps, xenon flash lamps, lasers, laser diodes, light emitting diodes, infrared lasers, infrared laser diodes, infrared light-emitting diodes, infrared lamps, or any other ultraviolet, visible, or infrared radiation source readily apparent to one skilled in the art, and others described in the art, such as in Research Disclosure, September, 1996, item 38957. Particularly useful infrared exposure means include laser diodes, including laser diodes that are modulated to increase imaging efficiency using what is known as multi-longitudinal exposure techniques as described in U.S. Pat. No. 5,780,207 (Mohapatra et al.). Other exposure techniques are described in U.S. Pat. No. 5,493,327 (McCallum et al.). In some embodiments, the materials are sensitive to radiation in the range of from about at least 300 nm to about 1400 nm, and preferably from about 300 nm to about 850 nm. In other embodiments, the materials are sensitive to radiation at 700 nm or greater (such as from about 750 to about 1150 nm).

Thermal development conditions will vary, depending on the construction used but will typically involve heating the imagewise exposed material at a suitably elevated temperature, for example, from about 50° C. to about 250° C. (preferably from about 80° C. to about 200° C. and more preferably from about 100° C. to about 150° C.) for at least 1 second to less than 15 seconds, and preferably for from 1 to about 10 seconds. In more preferred embodiments the development time is from about 5 to about 10 seconds and in most preferred embodiments, the development time is from about 5 to about 8 seconds. Development can be accomplished using any suitable heating means, such as contacting the material with a heated drum, plates, or rollers, or by providing a heating resistance layer on the rear surface of the material and supplying electric current to the layer so as to heat the material.

Use as a Photomask

The photothermographic materials can be sufficiently transmissive in the range of from about 350 to about 450 nm in non-imaged areas to allow their use in a method where there is a subsequent exposure of an ultraviolet or short wavelength visible radiation sensitive imageable medium. The heat-developed materials absorb ultraviolet or short wavelength visible radiation in the areas where there is a visible image and transmit ultraviolet or short wavelength visible radiation where there is no visible image. The heat-developed materials may then be used as a mask and positioned between a source of imaging radiation (such as an ultraviolet or short wavelength visible radiation energy source) and an imageable material that is sensitive to such imaging radiation, such as a photopolymer, diazo material, photoresist, or photosensitive printing plate. Exposing the imageable material to the imaging radiation through the visible image in the exposed and heat-developed photothermographic material provides an image in the imageable material. This method is particularly useful where the imageable medium comprises a printing plate and the photothermographic material serves as an imagesetting film.

Thus, the present invention provides a method of forming a visible image comprising:

(A) imagewise exposing the photothermographic material that has a transparent support to electromagnetic radiation to form a latent image,

(B) simultaneously or sequentially, heating said exposed photothermographic material for sufficient time less than 15 seconds and within a temperature range of from 110 to 150° C. to develop said latent image into a visible image having a Dₘₐₓ of at least 3.0.

(C) positioning the exposed and heat-developed photothermographic material between a source of imaging radiation and an imageable material that is sensitive to the imaging radiation, and

(D) exposing the imageable material to the imaging radiation through the visible image in the exposed and heat-developed photothermographic material to provide an image in the imageable material.

The following examples are provided to illustrate the practice of the present invention and the invention is not meant to be limited thereby.

Materials and Methods for the Examples:

All materials used in the following examples are readily available from standard commercial sources, such as Aldrich Chemical Co. (Milwaukee Wis.) unless otherwise specified. All percentages are by weight unless otherwise indicated. The following additional terms and materials were used.

BZT is benzotriazole.

CAB 171-15S is a cellulose acetate butyrate resin available from Eastman Chemical Co (Kingsport, Tenn.).

DESMODUR® N3300 is a trimer of an aliphatic hexamethylene diisocyanate available from Bayer Chemicals (Pittsburgh, Pa.).

LOWINOX® 22IB46 is 1,1′-bis(2-hydroxy-3,5-dimethyl)-isobutaneavailable from Great Lakes Chemical (West Lafayette, Ind.).

PARALOID® A-21 is an acrylic copolymer available from Rohm and Haas (Philadelphia, Pa.).

PIOLOFORM® BL-16, and BM-18 are polyvinyl butyral resins available from Wacker Polymer Systems (Adrian, Mich.).

MEK is methyl ethyl ketone (or 2-butanone).

Vinyl Sulfone-1 (VS-1) is described in U.S. Pat. No. 6,143,487 and has the structure shown below.

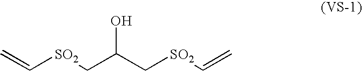

Antifoggant-A (AF-A) is 2-Pyridyl tribromomethylsulfone (2-tribromomethylsulfonyl pyridine) and has the structure shown below.

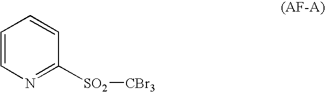

Antifoggant-B (AF-B) is ethyl-2-cyano-3-oxobutanoate and has the structure shown below.

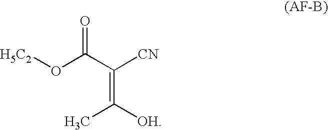

Sensitizing Dye A has the structure shown below.

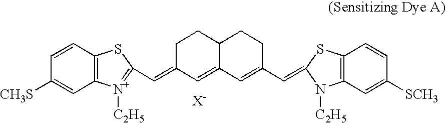

Backcoat Dye BC-1 and Comparative Dye CD-1 is cyclobutenediylium, 1,3-bis[2,3-dihydro-2,2-bis[[1-oxohexyl)oxy]methyl]-1H-perimidin-4-yl]-2,4-dihydroxy-, bis(inner salt). It is believed to have the structure shown below.

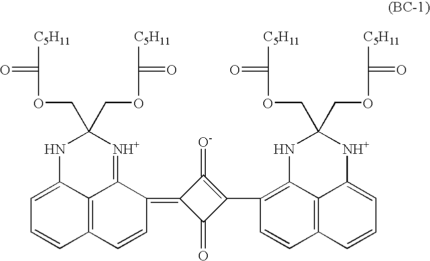

Acutance Dye AD-1 has the following structure:

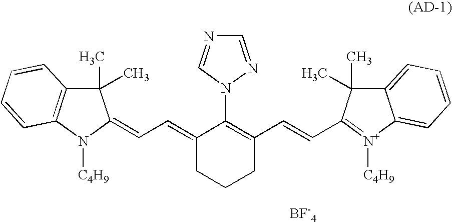

Tinting Dye TD-1 has the following structure:

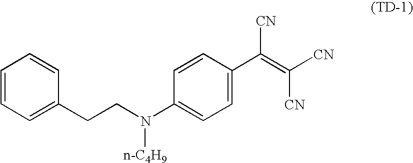

Support Dye SD-1 has the following structure:

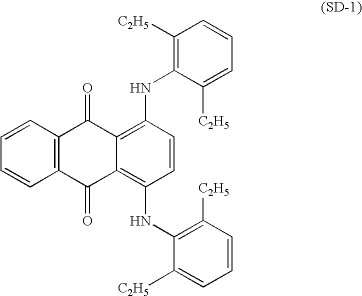

### EXAMPLE 1-3:

Photothermographic Formulation:

A photothermographic imaging formulation was prepared as follows:

A preformed silver halide, silver carboxylate soap dispersion, was prepared in similar fashion to that described in U.S. Pat. No. 5,939,249 (noted above). The core shell silver halide emulsion had a silver iodobromide core with 8% iodide, and a silver bromide shell doped with iridium and copper. The core made up 25% of each silver halide grain, and the shell made up the remaining 75%. The mean grain size was between 0.055 and 0.06 μm. The preformed silver halide, silver carboxylate soap was washed in a centrifugal filter until the wash water had a conductivity of less than 50 μS/cm. The wet soap was then dried in a heated vacuum drier at about 25 torr with a nitrogen sweep until the moisture content was less than 0.5%. A preformed silver halide, silver carboxylate soap dispersion was made by mixing 26.1 % preformed silver halide, silver carboxylate soap, 2.1% PIOLOFORM® BM-18 polyvinyl butyral binder, and 71.8% MEK, and homogenizing three times at 8000 psi (55 MPa).

Four silver containing formulations, S-1, S-2, S-3, and S-4, were prepared, each having 174 parts of the above preformed silver halide, silver carboxylate soap dispersion. To each formulation was added 1.6 parts of a 15% solution of pyridinium hydrobromide perbromide in methanol, with stirring. After 60 minutes of mixing, 2.1 parts of an 11% zinc bromide solution in methanol was added to each batch. Stirring was continued and after 30 minutes, a solution of 0.15 parts 2-mercapto-5-methylbenzimidazole, 0.007 parts Sensitizing Dye A, 1.7 parts of 2-(4-chlorobenzoyl)benzoic acid, 10.8 parts of methanol, and 3.8 parts of MEK was added to each batch. After stirring for 75 minutes, the temperature was lowered to 10° C., and 26 parts of PIOLOFORM® BM-18 and 20 parts of PIOLOFORM® BL-16 were added to each batch. Mixing was continued for another 30 minutes.

The formulations for each batch were completed by adding the materials shown below. 5 Minutes was allowed between the additions of each component.

Solution A containing:

| | |
|---|---|
| Antifoggant (AF-A) | See TABLE I |
| Tetrachlorophthalic acid (TCPA) | 0.37 parts |
| 4-Methylphthalic acid (4-MPA) | See TABLE I |
| MEK | 21 parts |
| Methanol | 0.36 parts |
| LOWINOX ® 22IB46 | 9.5 parts |
| DESMODUR ® N3300 | 0.66 parts in 0.33 parts MEK |
| Phthalazine (PHZ) | 1.3 parts in 6.3 parts MEK |

Topcoat Formulation:

Two topcoat formulations, TC-1 and TC-2, were prepared by mixing the following ingredients:

TABLE I

| | Antifoggant | 4-Methylphthalic Acid |
|---|---|---|
| Silver Formulation | (AF-A) | (4-MPA) |
| S-1 | 0.8 parts | 0.48 parts |
| S-2 | 0.8 parts | 0.72 parts |
| S-3 | 0.8 parts | 0.95 parts |
| S-4 | 1.1 parts | 0.95 parts |

Five photothermographic materials were coated from the four imaging (silver) formulations and two topcoat formulations. They are listed below in TABLE III.

TABLE III

| | | | AF-A | 4-MPA | BZT |
|---|---|---|---|---|---|
| | Silver | Topcoat | [mol/ | [mol/ | [mol/ |
| Film | Formulation | Formulation | mol Ag] | mol Ag] | mol Ag] |
| Comparative 1 | S-1 | TC-1 | 0.020 | 0.027 | 0.022 |
| Comparative 2 | S-2 | TC-1 | 0.020 | 0.040 | 0.022 |
| Example 1 | S-3 | TC-1 | 0.020 | 0.053 | 0.022 |
| Example 2 | S-3 | TC-2 | 0.020 | 0.053 | 0.011 |
| Example 3 | S-4 | TC-1 | 0.029 | 0.053 | 0.022 |

The photothermographic imaging (silver) formulation and topcoat formulation were simultaneously coated onto a 178 μm polyethylene terephthalate film, tinted blue with support dye SD-1, to provide photothermographic materials. The silver containing formulation was coated to obtain about 2 g of silver/m². The topcoat formulation was coated to obtain about 0.2 g/ft² (2.2 g/m² ) dry coating weight, and an optical density (absorbance) on the imaging side of about 1.0 at 810 nm. Immediately after coating, samples were dried in a forced air oven at between 80 and 95° C. for between 4 and 5 minutes.

The backside of the support had been coated with an antihalation and antistatic layer having an absorbance greater than 0.3 between 805 and 815 nm, and a resistivity of less than 10¹¹ ohms/square.

Each photothermographic material was cut into strip samples, exposed with a laser sensitometer at 810 nm, and heat-developed, to generate continuous tone wedges with image densities varying from a minimum density (Dₘᵢₙ) to a maximum density (Dₘₐₓ) possible for the exposure source and development conditions.

Heat development was carried out on a 6-inch diameter (15.2 cm) heated rotating drum. The strip contacted the drum for 210 degrees of its revolution, about 11 inches (28 cm). Two different development conditions were used.

| | |
|---|---|
| (DC-1) | 122.5° C. for 15 seconds at a transport rate of 0.733 inches/sec |
| | (112 cm/min). |
| (DC-2) | 132.5° C. for 5 seconds at a transport rate of 2.20 inches/sec |
| | (335 cm/min). |

The density of each of these wedges was then measured with a computer densitometer to obtain graphs of density verses log exposure (that is, D log E curves). Both Dₘᵢₙ and Dₘₐₓ were recorded for each example at each development condition.

The results are shown below in TABLE IV. All of the examples, both comparative and inventive, have similar Dₘᵢₙ and Dₘₐₓ at the 15-second development condition (DC-1). However, at the 5-second development condition (DC-2), the Dₘₐₓ results are very different. Comparing the data in TABLE III with that in TABLE IV, it is clear that the two lowest levels of 4-MPA (Comparative Examples 1 and 2) did not give a Dₘₐₓ above 2.6 at the 5-second development conditions. In Examples 1-3, the highest Dₘₐₓ was obtained with the sample with the lowest level of BZT.

Additionally, Inventive Example 3, which had the highest level of organic antifoggant AF-1, in addition to having a high Dₘₐₓ, exhibited a Dₘᵢₙ increase of only 0.005 after 18 months of aging at approximately 70° F. and 50% relative humidity before exposure and development. This improvement is even greater than that of Inventive Examples 1 and 2, each of which exhibited a Dₘᵢₙ increase of only 0.01 when stored, imaged, and then developed under the same conditions.

The results further show that to obtain an image Dₘₐₓ of at least 3.0 when the heat development conditions are 5 seconds at 132.5° C., it is necessary to have more than 0.040 moles of a toner of Structure I per mole of total silver. Also, if benzotriazole is present, it is preferable to have it at a level of less than 0.022 moles per mole of total silver. Additionally, it is preferable to have an organic polyhalo antifoggant compound at a level of at least 0.020 moles and preferably at least 0.029 moles per mole of total silver.

TABLE IV

| | 15-sec | 5-sec | | 5-sec | |
|---|---|---|---|---|---|
| Film | Dmin | Dmin | 15-sec Dmax | Dmax | Comments |
| Comparative 1 | 0.22 | 0.22 | 3.9 | 1.3 | Comparative |
| Comparative 2 | 0.23 | 0.22 | 4.0 | 2.6 | Comparative |
| Example 1 | 0.23 | 0.22 | 3.9 | 3.2 | Invention |
| Example 2 | 0.23 | 0.22 | 3.9 | 3.8 | Invention |
| Example 3 | 0.22 | 0.22 | 3.9 | 3.1 | Invention |

### EXAMPLES 4-8:

Photothermographic imaging formulations were prepared in a manner similar to that described in Examples 1 through 3 using silver formulation S-2. The changes to the formulations are shown below in TABLE V:

TABLE V

| Silver | | | Lowinox ® | |
|---|---|---|---|---|
| Formulation | 4-MPA | PHZ | 22IB46 | TCPA |
| S-5 | 0.72 parts | 1.3 parts | 9.5 parts | 0.37 parts |
| S-6 | 0.95 parts | 1.7 parts | 11.4 parts | 0.18 parts |
| S-7 | 0.95 parts | 1.7 parts | 11.4 parts | 0.55 parts |
| S-8 | 0.95 parts | 1.3 parts | 9.5 parts | 0.37 parts |
| S-9 | 0.95 parts | 0.9 parts | 7.6 parts | 0.18 parts |
| S-10 | 0.95 parts | 0.9 parts | 7.6 parts | 0.55 parts |
| S-11 | 0.95 parts | 1.7 parts | 7.6 parts | 0.18 parts |
| S-12 | 0.95 parts | 1.7 parts | 7.6 parts | 0.55 parts |

Six topcoat formulations were prepared. TC-1 and TC-2 were prepared in the same manner as described in Examples 1-3. Topcoat formulations TC-3, TC-4, TC-5, and TC-6 were prepared in the same manner as TC-2, but with the changes shown below in TABLE VI. Topcoat formulations TC-1 and TC-2 are shown again for reference.

TABLE VI

| | Benzotriazole | Antifoggant-B | Vinyl sulfone |
|---|---|---|---|
| Topcoat Formulation | (BZT) | (AF-B) | (VS-1) |
| TC-1 | 0.18 parts | 0.16 parts | 0.24 parts |
| TC-2 | 0.09 parts | 0.16 parts | 0.24 parts |
| TC-3 | 0.09 parts | 0 parts | 0.36 parts |
| TC-4 | 0.09 parts | 0.32 parts | 0.12 parts |
| TC-5 | 0.09 parts | 0 parts | 0.12 parts |
| TC-6 | 0.09 parts | 0.32 parts | 0.36 parts |

Photothermographic materials were prepared as in Examples 1-3.

Fourteen photothermographic materials were coated from the eight photothermographic imaging (silver) formulations and six topcoat formulations. Their formulations are shown below in TABLE VII and TABLE VIII.

As shown in these two tables, only the inventive examples have all of the following:
at least 0.042 moles of a compound of Structure I per mole of silver,
at least 0.10 moles of a compound of Structure II per mole of silver, and

at most 0.32 moles of reducing agents per mole of silver. Inventive Examples 4 through 8 also have less than 0.022 moles of benzotriazole per mole of silver, which is a preferred embodiment of the invention.

TABLE VII

| Film | Silver Formulation | Topcoat Formulation |
|---|---|---|
| Comparative 3 | S-5 | TC-1 |
| Comparative 4 | S-6 | TC-3 |
| Comparative 5 | S-6 | TC-4 |
| Comparative 6 | S-7 | TC-5 |
| Comparative 7 | S-7 | TC-6 |
| Comparative 8 | S-9 | TC-3 |
| Comparative 9 | S-9 | TC-4 |
| Comparative 10 | S-10 | TC-5 |
| Comparative 11 | S-10 | TC-6 |
| Example 4 | S-8 | TC-2 |
| Example 5 | S-11 | TC-3 |
| Example 6 | S-11 | TC-4 |
| Example 7 | S-12 | TC-5 |
| Example 8 | S-12 | TC-6 |

TABLE VIII

| | | | Lowinox ® | | |
|---|---|---|---|---|---|
| | 4-MPA | PHZ | 22IB46 | TCPA | BZT |
| | [mol/ | [mol/ | [mol/ | [mol/ | [mol/ |
| Film | mol Ag] | mol Ag] | mol Ag] | mol Ag] | mol Ag] |
| Comparative 3 | 0.040 | 0.10 | 0.30 | 0.012 | 0.022 |
| Comparative 4 | 0.053 | 0.13 | 0.36 | 0.006 | 0.011 |
| Comparative 5 | 0.053 | 0.13 | 0.36 | 0.006 | 0.011 |
| Comparative 6 | 0.053 | 0.13 | 0.36 | 0.018 | 0.011 |
| Comparative 7 | 0.053 | 0.13 | 0.36 | 0.018 | 0.011 |
| Comparative 8 | 0.053 | 0.07 | 0.24 | 0.006 | 0.011 |
| Comparative 9 | 0.053 | 0.07 | 0.24 | 0.006 | 0.011 |
| Comparative 10 | 0.053 | 0.07 | 0.24 | 0.018 | 0.011 |
| Comparative 11 | 0.053 | 0.07 | 0.24 | 0.018 | 0.011 |
| Example 4 | 0.053 | 0.10 | 0.30 | 0.012 | 0.011 |
| Example 5 | 0.053 | 0.13 | 0.24 | 0.006 | 0.011 |
| Example 6 | 0.053 | 0.13 | 0.24 | 0.006 | 0.011 |
| Example 7 | 0.053 | 0.13 | 0.24 | 0.018 | 0.011 |
| Example 8 | 0.053 | 0.13 | 0.24 | 0.018 | 0.011 |

Each photothermographic material was cut into strip samples, exposed with a laser sensitometer at 810 nm, and heat-developed, to generate continuous tone wedges with image densities varying from a minimum density (Dₘᵢₙ) to a maximum density (Dₘₐₓ) possible for the exposure source and development conditions.

Heat development was carried out on a 6-inch diameter (15.2 cm) heated rotating drum. The strip contacted the drum for 210 degrees of its rotation, about 11 inches (28 cm). Two different development conditions were used.

| | |
|---|---|
| (DC-1) | 122.5° C. for 15 seconds at transport rate of 0.733 inches/sec |
| | (112 cm/min). |
| (DC-3) | 129° C. for 8 seconds at a transport rate of 1.38 inches/sec |
| | (209 cm/min). |

The density of each of these wedges was then measured with a computer densitometer to obtain graphs of density verses log exposure (that is, D log E curves). Both Dₘᵢₙ and Dₘₐₓ were recorded for each example at each development condition.

Two measurements were made on each strip sample. For the first measurement, the computer densitometer was equipped with a visible filter with a transmittance peak at about 530 nm, as used for the density measurements described above. In the second measurement, the computer densitometer was fitted with a blue filter with a transmission peak at about 440 nm. By measuring the density on each wedge with both of these filters and subtracting the blue density from the visible density, a measure of blueness of the image tone was obtained. The difference between the visible and blue density at a visible density of 2.0 is recorded below in TABLE IX as “15-sec Tone” or “8-sec Tone”, depending on the processing time. A higher number represents a bluer image tone. A tone of 0.2 is acceptable.

Post-Processing Stability:

A continuous tone wedge strip of each photothermographic material that had been developed at 129° C. for 8 seconds was illuminated with fluorescent lighting for 6 hours at 21° C./50% relative humidity. The illumination at the surface of each strip was 90-120 foot-candles (968-1291 lux). Each sample was then re-scanned using the computer densitometer with a blue filter.

The samples were then stacked together and bagged tightly in a high-density, flat-black polyethylene bag. A strip of polyethylene terephthalate was placed above and below the stack of film samples. The bagged samples were then placed in an oven and heated at 68-74° C. for 3 hours. After the samples were cooled to room temperature, they were removed from the bag and rescanned with the same densitometer. The change in density at each position on the wedge was plotted, and the maximum density change recorded to determine the high temperature post-processing stability. The results are recorded in TABLE VIII as “8-sec ΔDens”. For these samples, a density change of 1.0 or higher is indicative of poor post-processing stability.

Pre-Processing Stability:

Unexposed strips of each photothermographic material were stacked together and bagged tightly in a high-density, flat-black polyethylene bag. A strip of polyethylene terephthalate was placed above and below the stack of film samples. The bagged samples were placed for one week in an environmental chamber controlled to 49° C. and 50% relative humidity. After this, they were removed, exposed with a laser sensitometer at 810 nm, and heat-developed as described above at 129° C. for 8 seconds, to generate continuous tone wedges with image densities varying from a minimum density (Dₘᵢₙ) to a maximum density (Dₘₐₓ) possible for the exposure source and development conditions. The Dₘₐₓ values are recorded in TABLE VIII as “8-sec Age Dₘₐₓ”. For these samples, a Dₘₐₓ below about 3.0 is indicative of poor pre-processing stability.

Results:

All of the examples, both Comparative and Invention, had similar Dₘᵢₙ, Dₘₐₓ, and tone values when developed under the 15-second development condition (DC-1). However, there are significant differences in Dₘₐₓ, tone, post-processing stability, and pre-processing stability when samples are developed under the 8-second development conditions (DC-3). A comparison of the data of TABLES VII and VIII with that of TABLE IX, clearly indicates that only the inventive examples gave acceptable results under the 8-second processing conditions.

TABLE IX

| | 15-sec | 15-sec | 15-sec | 8-sec | 8-sec | 8-sec | 8-sec | 8-sec Age |
|---|---|---|---|---|---|---|---|---|
| Film | Dmin | Dmax | Tone | Dmin | Dmax | Tone | ΔDens | Dmax |
| Comparative 3 | 0.22 | 4.1 | 0.2 | 0.22 | 3.8 | 0.1 | 0.7 | 2.7 |
| Comparative 4 | 0.24 | 4.0 | 0.2 | 0.26 | 4.0 | 0.2 | 1.0 | 4.3 |
| Comparative 5 | 0.23 | 4.0 | 0.2 | 0.24 | 4.1 | 0.2 | 1.2 | 4.2 |
| Comparative 6 | 0.23 | 3.7 | 0.2 | 0.24 | 3.8 | 0.2 | 1.3 | 3.9 |
| Comparative 7 | 0.23 | 4.0 | 0.2 | 0.23 | 3.9 | 0.2 | 1.2 | 3.7 |
| Comparative 8 | 0.22 | 4.2 | 0.2 | 0.21 | 4.2 | 0.2 | 0.5 | 1.1 |
| Comparative 9 | 0.22 | 4.1 | 0.2 | 0.21 | 3.4 | 0.2 | 0.7 | 1.6 |
| Comparative 10 | 0.22 | 3.9 | 0.2 | 0.21 | 2.8 | 0.0 | 1.0 | 0.7 |
| Comparative 11 | 0.22 | 3.7 | 0.2 | 0.21 | 1.7 | −0.1 | 0.9 | 0.3 |
| Invention Example 4 | 0.22 | 4.0 | 0.2 | 0.22 | 3.9 | 0.2 | 0.7 | 4.0 |
| Invention Example 5 | 0.22 | 3.8 | 0.2 | 0.22 | 3.8 | 0.2 | 0.3 | 3.9 |
| Invention Example 6 | 0.22 | 4.1 | 0.2 | 0.22 | 4.1 | 0.2 | 0.4 | 3.9 |
| Invention Example 7 | 0.22 | 3.5 | 0.2 | 0.22 | 3.7 | 0.2 | 0.3 | 3.8 |
| Invention Example 8 | 0.22 | 3.8 | 0.2 | 0.23 | 3.9 | 0.2 | 0.4 | 3.9 |

The invention has been described in detail with particular reference to certain preferred embodiments thereof, but it will be understood that variations and modifications can be effected within the spirit and scope of the invention.

1. A black-and-white photothermographic material that comprises a support having on one side thereof, one or more thermally developable imaging layers comprising a binder and in reactive association, a photosensitive silver halide, a non-photosensitive source of reducible silver ions, and a reducing agent composition for said non-photosensitive source reducible silver ions,
said material further comprising at least one compound represented by the following Structure I and at least one compound represented by the following Structure II: 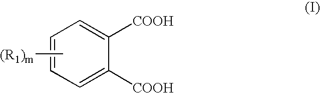
wherein R₁ represents an alkyl group, aryl group, alkoxy group, aryloxy group, halo group, cyano group, or nitro group, m is 0 or an integer up to 4, and when m is greater than or equal to 2, a plurality of R₁ groups may be the same or different, and when present, two or more R₁ groups may form a fused aliphatic, aromatic, or heterocyclic fused ring, with the proviso that when m is 4, all R₁ are not chloro, 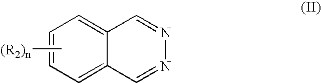
wherein R₂ represents hydrogen or a substituent, n is 0 or an integer up to 4, and when n is greater than or equal to 2, a plurality of R₂ groups may be the same or different and when present, two or more R₂ groups may form a fused aliphatic, aromatic, or heterocyclic ring,
wherein the amount of said reducing agent composition is at least 0.10 and up to and including 0.32 mol/mol of total silver, the amount of the compound represented by Structure I is at least 0.042 mol/mol of total silver, and the amount of the compound represented by Structure II is at least 0.10 mol/mol of total silver, and
wherein said material has, at the exposure wavelength, a total optical density of at least 0.1 of all layers on the imaging layer side of said support.

2. The material of claim 1 wherein said reducing agent composition includes an o-bisphenol or a hindered phenol.

3. The material of claim 2 wherein said reducing agent comprises a compound represented by Structure III: 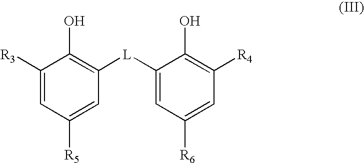
wherein R₃ and R₄ each independently represents a substituted or unsubstituted linear, branched, or cyclic alkyl group having 1 to 20 carbon atoms, R₅ and R₆ each independently represents hydrogen or a monovalent substituent such as an alkyl group, aryl group, halogen atom, or alkoxy group, and L represents —S— or —CHR₇ in which R₇ represents a hydrogen atom or a substituted or unsubstituted linear, branched, or cyclic alkyl group having 1 to 20 carbon atoms.

4. The material of claim 3 comprising said compound represented by Structure I is present in an amount of at least 0.053 mol/mol of total silver and said compound represented by Structure III is present in an amount of at most 0.25 mol/mol of total silver.

5. The photothermographic material of claim 1 wherein benzotriazole is absent or is present in an amount of at most 0.02 moles per mole of total silver.

6. The photothermographic material of claim 1 wherein the photosensitive silver halide is chemically sensitized with a compound containing sulfur, gold, tellurium, or selenium.

7. The material of claim 1 wherein the amount of total silver is from about 0.01 to about 0.02 mol/m².

8. The material of claim 1 wherein said non-photosensitive source of reducible silver ions is a silver salt of an aliphatic carboxylate or a mixture of silver salts of aliphatic carboxylates, at least one of which is silver behenate.

9. The material of claim 1 further comprising an organic polyhalo antifoggant in an amount of from about 0.02 to about 0.10 mol/mol of total silver or a benzotriazole compound in an amount of from about 0.005 to about 0.022 mol/mol of total silver.

10. The material of claim 1 wherein said photosensitive silver halide is present as preformed silver halide grains having an average size of from about 0.01 to about 0.06 μm.

11. The material of claim 1 wherein the compound represented by Structure I is present in an amount of from about 0.042 to about 0.08 mol/mol of total silver, the compound represented by Structure II is present in an amount of from about 0.10 to about 0.2 mol/mol of total silver, and said reducing agent composition is present in an amount of from about 0.10 to about 0.32 mol/mol of total silver, and the amount of total silver is from about 0.01 to about 0.02 mol/m².

12. The material of claim 1 wherein said photosensitive silver halide is spectrally sensitized to the infrared radiation.

13. The material of claim 1 further comprising an antihalation composition on the backside of said support.

14. The material of claim 1 having at the exposure wavelength a total optical density of at least 0.6 of all layers on the imaging layer side of said support and a total optical density of at least 0.2 of all layers on the backside of said support.

15. The material of claim 1 further comprising a buried metal oxide conductive layer on the backside of said support.

16. A black-and-white photothermographic material that comprises a transparent polymeric support having on one side thereof one or more thermally developable imaging layers comprising predominantly one or more hydrophobic binders comprising polyvinyl butyral, and in reactive association:
preformed photosensitive silver bromide or silver iodobromide present as tabular and/or cubic grains, which grains have an average size of from about 0.01 to about 0.06 μm, and are spectrally sensitized to infrared radiation,
a non-photosensitive source of reducible silver ions that includes silver behenate,
a reducing agent composition for said non-photosensitive source reducible silver ions comprising a compound represented by Structure III, 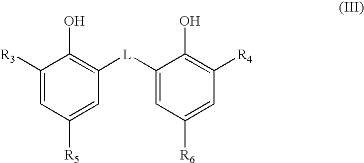
wherein R₃ and R₄ each independently represents a substituted or unsubstituted linear, branched, or cyclic alkyl group having 1 to 20 carbon atoms, R₅ and R₆ each independently represents hydrogen or a monovalent substituent such as an alkyl group, aryl group, halogen atom, or alkoxy group, and L represents —S— or —CHR₇ in which R₇ represents a hydrogen atom or a substituted or unsubstituted linear, branched, or cyclic alkyl group having 1 to 20 carbon atoms,
said material further comprising an organic polyhalo antifoggant in an amount of from about 0.029 to about 0.10 mol/mol of total silver, a benzotriazole compound in an amount of from about 0.005 to about 0.022 mol/mol of total silver, an isocyanate, and a propenenitrile,
said material further comprising at least one compound represented by the following Structure I and at least one compound represented by the following Structure II: 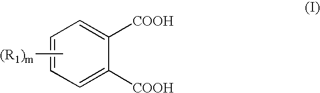
wherein, R₁ represents an alkyl group, aryl group, alkoxy group, aryloxy group, halo group, cyano group, or nitro group, m is 0 or an integer up to 4, and when m is greater than or equal to 2, a plurality of R₁ groups may be the same or different, and when present, two or more R₁ groups may form a fused aliphatic, aromatic, or heterocyclic fused ring, with the proviso that when m is 4, all R₁ are not chloro, and 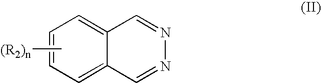
wherein R₂ represents hydrogen or a substituent, n is 0 or an integer up to 4, and when n is greater than or equal to 2, a plurality of R₂ groups may be the same or different and when present, two or more R₂ groups may form a fused aliphatic, aromatic, or heterocyclic ring
wherein the amount of said reducing agent composition is from about 0.10 to about 0.32 mol/mol of total silver, the amount of the compound represented by Structure I is from about 0.042 to about 0.08 mol/mol of total silver, and the amount of the compound represented by Structure II is from about 0.10 to about 0.2 mol/mol of total silver, and
a protective layer disposed over said one or more thermally developable imaging layers, said material comprising total silver of from about 0.01 to about 0.02 mol/m²,
said material further having at the exposure wavelength a total optical density of at least 0.6 of all layers on the imaging layer side of said support and a total optical density of at least 0.2 of all layers on the backside of said support.

17. The material of claim 16 further comprising a backside antistatic layer having a resistivity of from about 10⁵ to about 10¹² ohms/square.

18. A method of forming a visible image comprising:
A) imagewise exposing a photothermographic material to electromagnetic radiation to form a latent image,
B) simultaneously or sequentially, heating said exposed photothermo-graphic material for 1 to less than 15 seconds to develop said latent image into a visible image,
said photothermographic material comprising a support having on one side thereof, one or more thermally developable imaging layers comprising a binder and in reactive association, a photosensitive silver halide, a non-photosensitive source of reducible silver ions, and a reducing agent composition for said non-photosensitive source reducible silver ions,
said material further comprising at least one compound represented by the following Structure I and at least one compound represented by the following Structure II: 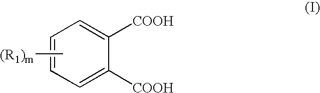
wherein R₁ represents an alkyl group, aryl group, alkoxy group, aryloxy group, halo group, cyano group, or nitro group, m is 0 or an integer up to 4, and when m is greater than or equal to 2, a plurality of R₁ groups may be the same or different, and when present, two or more R₁ groups may form a fused aliphatic, aromatic, or heterocyclic fused ring, with the proviso that when m is 4, all R₁ are not chloro, 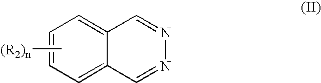
wherein R₂ represents hydrogen or a substituent, n is 0 or an integer up to 4, and when n is greater than or equal to 2, a plurality of R₂ groups may be the same or different and when present, two or more R₂ groups may form a fused aliphatic, aromatic, or heterocyclic ring, and
wherein the amount of said reducing agent composition is at least 0.10 and up to and including 0.32 mol/mol of total silver, the amount of the compound represented by Structure I is at least 0.042 mol/mol of total silver, and the amount of the compound represented by Structure II is at least 0.10 mol/mol of total silver.

19. The method of claim 18 comprising heating said exposed photothermographic material for from about 5 to about 10 seconds to develop said latent image into a visible image.

20. The method of claim 18 wherein said heating is carried out at a temperature of from about 100 to about 150° C.

21. The method of claim 18 wherein said photothermographic material comprises a transparent support and said image-forming method further comprises:
C) positioning said exposed and heat-developed photothermographic material with the visible image thereon between a source of imaging radiation and an imageable material that is sensitive to said imaging radiation, and
D) thereafter exposing said imageable material to said imaging radiation through the visible image in said exposed and heat-developed photothermographic material to provide an image in said imageable material.

22. The method of claim 18 wherein said photothermographic material is imaged at an exposure wavelength greater than 700 nm.

23. The method of claim 18 comprising using said visible image for a medical diagnosis.

24. A method of forming a visible image comprising:
A) imagewise exposing a photothermographic material that has a transparent support to electromagnetic radiation to form a latent image,
B) simultaneously or sequentially, heating said exposed photothermographic material for sufficient time less than 15 seconds and temperature to develop said latent image into a visible image having a Dₘₐₓ of at least 3.0,
said photothermographic material comprising a support having on one side thereof, one or more thermally developable imaging layers comprising a binder and in reactive association, a photosensitive silver halide, a non-photosensitive source of reducible silver ions, and a reducing agent composition for said non-photosensitive source reducible silver ions,
said material further comprising at least one compound represented by the following Structure I and at least one compound represented by the following Structure II: 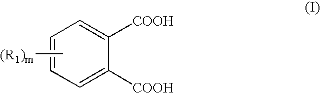
wherein I, R₁ represents an alkyl group, aryl group, alkoxy group, aryloxy group, halo group, cyano group, or nitro group, m is 0 or an integer up to 4, and when m is greater than or equal to 2, a plurality of R₁ groups may be the same or different, and when present, two or more R₁ groups may form a fused aliphatic, aromatic, or heterocyclic fused ring, with the proviso that when m is 4, all R₁ are not chloro, 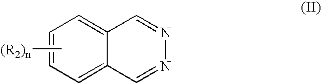
wherein R₂ represents hydrogen or a substituent, n is 0 or an integer up to 4, and when n is greater than or equal to 2, a plurality of R₂ groups may be the same or different and when present, two or more R₂ groups may form a fused aliphatic, aromatic, or heterocyclic ring, and
wherein the amount of said reducing agent composition is at least 0.10 and up to and including 0.32 mol/mol of total silver, the amount of the compound represented by Structure I is at least 0.042 mol/mol of total silver, and the amount of the compound represented by Structure II is at least 0.10 mol/mol of total silver.

25. A method of forming a visible image comprising:
A) imagewise exposing the material of claim 16 to electromagnetic radiation to form a latent image,
B) simultaneously or sequentially, heating said exposed photothermographic material for from about 5 to about 10 seconds to develop said latent image into a visible image.
